(19) United States
(12) Patent Application Publication
(10) Pub. No.: US 2015/0296847 A1
(43) Pub. Date: Oct. 22, 2015

(54) PROCESS FOR MAKING COATED VEGETABLES

(71) Applicants: David JAMES, Peterborough, Cambridgeshire (GB); Pamela HUME, Scarborough (GB); McCain Foods Limited, Florenceville-Bristol (CA)

(72) Inventors: David James, Peterborough, Cambridgeshire (GB); Pamela Hume, Scarborough (GB)

(73) Assignee: McCain Foods Limited, Florenceville-Bristol (CA)

(21) Appl. No.: 14/439,946

(22) PCT Filed: Nov. 4, 2013
(86) PCT No.: PCT/IB13/02443

§ 371 Date: Apr. 30, 2015

Related U.S. Application Data
(60) Provisional application No. 61/722,431, filed on Nov. 5, 2012.

(51) Int. Cl. A23L 1/212; A23L 1/00; A23L 1/01; A23L 1/272

(52) U.S. Cl. CPC A23L 1/2125; A23L 1/272; A23L 1/0047; A23L 1/0107; A23V 2002/00

(57) ABSTRACT

The present application relates to a process of producing an oil fried, batter coated vegetable food article. The process optionally relates to the production of an oil fried, batter coated vegetable article where the batter coating covers a vegetable, such as a potato portion, optionally a French fry. The present application further relates to a process of producing an oil-fried starchy vegetable food article in the absence of a batter. Optionally the vegetable is an oil fried potato food article. The present disclosure further relates to a steam treatment apparatus which produces steam and creates a steam environment for a food product to pass through prior to the frying of the food product in oil. The food product may be at least partially formed from one or more vegetables and coated in a coating containing starch that is treated with steam prior to being fried in oil. Alternatively, the food product may be a portion of a starchy vegetable which is blanched prior to being steamed treated and fried in oil.

### CROSS-REFERENCE TO RELATED APPLICATIONS

The present application claims the benefit of priority from co-pending U.S. provisional application No. 61/722,431 filed on Nov. 5, 2012, the contents of which are incorporated herein by reference in their entirety.

### FIELD

The application relates to a process for producing a fried, batter-coated food article such as a fried, batter-coated vegetable article. The process optionally relates to the production of a fried, batter-coated root vegetable article, such as a fried, batter-coated potato article.

### BACKGROUND

It is known to produce an oil fried, batter-coated food article, for example an oil fried, batter-coated potato article, using the process steps illustrated in FIG. 1 and generally designated 10.

Preparation. Taking the example of an oil fried, batter-coated potato article, the preparation step 12 may include such operations as peeling or washing to remove soil, for example if the potato skin is to be retained on the finished food article, cutting or processing to a desired shape and/or size.

The potato may be of any commercially available processing variety including, but not limited to, Maris Piper, Pentland Dell, Markies, Shepody, Premiere, Russet Burbank, Bintje, Innovator and Morene. Sweet potato may also be used.

Blanch. The blanching step 14 may comprise, for example immersing the uncooked potato article in heated water, deluging the uncooked potato article with hot water sprays or exposing the uncooked potato article to heated steam. Blanching of the potato article is conducted, for example to inactivate enzymes and remove sugars from the surface of the potato which, if not removed, would cause discolouration.

Dip. The dipping step 16 involves immersing the blanched potato article in a solution which further prevents discolouration due to iron oxidation. The solution typically contains Sodium Acid Pyrophosphate (SAPP).

Dry. The dipped potato article is then partially dried to reduce the moisture content thereof. Typically the moisture reduction is in the region of 3% to 20% by weight. This drying step 18 may be achieved by placing the dipped article in an elevated temperature environment, for example a drying oven. Alternatively, the dipped article may be allowed to dry at the prevailing ambient temperature.

Batter Coating. The dried potato article is then coated with batter. The batter coating step 20 may be achieved by any known means including, for example, a waterfall enrober, spraying or dipping.

Set. The batter-coated potato article is then subjected to a period of setting (step 22). Setting may advantageously take place at ambient temperature as the batter-coated potato article is conveyed from the batter coating location to the frying location.

Fry. The batter-coated potato article is then subjected to either one or two oil frying steps (steps 24 and 26).

Freeze. The fried, batter-coated potato article is allowed to cool and is then frozen (step 28) before subsequent packaging.

A typical process of the type described above is as follows: Incoming potatoes are first graded so as to select potatoes of a desired size and shape profile. The potatoes are then washed and peeled before being pre-heated in a hot water bath. The potatoes may then be cut into the desired size and shape for the finished potato article. For example, the potatoes may be cut into sticks if a French fry article is desired. Alternatively, the potatoes may be cut into halves, quarters or wedges. The above referenced shapes are examples and are not intended to be limiting. In yet a further embodiment the potatoes may remain whole after washing and peeling.

The washed, peeled and optionally cut potatoes are then blanched in a hot water bath. The blanching temperature and duration is dependent, for example upon the size and shape of the potatoes. Blanching may, for example, be conducted for between 8 and 20 minutes at a temperature of between 70 to 90 degrees centigrade. The blanched potatoes are then dipped in a SAPP containing solution before being dried. Drying time and temperature is again dependent, for example upon the size and shape of the potatoes. Typically, drying may be effected by placing the potatoes in a heated air environment having a temperature of between 30 to 70 degrees centigrade for between 5 and 15 minutes.

The potatoes are then coated with batter using conventional coating equipment. After batter coating, the batter-coated potato articles are passed before a blower which removes any excess batter before the batter remaining on the potatoes is allowed to set. Once the setting time has elapsed, the batter-coated potato articles are subjected to frying in oil. The frying time and temperature is again dependent, for example on the size and shape of the potatoes. For a two-step process the frying may comprise a first frying step typically of a minimum of 8 seconds at a minimum temperature of about 160° C. followed by a second frying step typically of a minimum of 25 seconds at a minimum temperature of about 170° C. After the first or second frying step, the potatoes are removed from the fryer and excess surface oil is removed by an air blower. The fried, batter-coated potato articles are then typically frozen to a temperature of maximum minus 8° C.

It is further known to produce an oil fried vegetable food article, for example an oil fried potato food article, using the process steps illustrated in FIG. 2 and generally designated 40.

Preparation. The preparation step 42 may include such operations as peeling or washing the potato to remove soil, for example if the potato skin is to be retained on the finished food article, cutting or processing to a desired shape and/or size. The potato may be of any commercially available processing variety as noted above.

Blanch. The blanching step 44 may comprise, for example immersing the uncooked potato article in heated water, deluging the uncooked potato article with hot water sprays or exposing the uncooked potato article to heated steam.

Dip. The dipping step 46 involves immersing the blanched potato article in a solution which further prevents discolouration due to iron oxidation. The solution typically contains Sodium Acid Pyrophosphate (SAPP).

Dry. The dipped potato article is then dried to reduce the moisture content thereof. Typically the moisture reduction is in the region of 3% to 20% by weight. This drying step 48 may be achieved by placing the dipped article in an elevated temperature environment, for example a drying oven. Alternatively, the dipped article may be allowed to dry at the prevailing ambient temperature.

Fry. The potato article is then subjected to at least one oil frying step 50.

Freeze. The fried potato article is allowed to cool and is then frozen (step 52) before subsequent packaging.

A typical process of the type described above is as follows: Incoming potatoes are first graded so as to select potatoes of a desired size and shape profile. The potatoes are then washed and peeled before being pre-heated in a hot water bath. The potatoes may then be cut into the desired size and shape for the finished potato article. For example, the potatoes may be cut into sticks if a French fry article is desired. Alternatively, the potatoes may be cut into halves, quarters or wedges. The above referenced shapes are examples and are not intended to be limiting. In yet a further embodiment the potatoes may remain whole after washing and peeling.

The washed, peeled and optionally cut potatoes are then blanched in a hot water bath. Blanching may, for example, be conducted for between 8 and 30 minutes at a temperature of between 70 to 95 degrees centigrade. The blanched potatoes are then dipped in a SAPP containing solution before being dried. Drying time and temperature is again dependent, for example on the size and shape of the potatoes. Typically, drying may be effected by placing the potatoes in a heated air environment having a temperature of between 30 to 70 degrees centigrade for between 5 and 25 minutes.

Once the drying time has elapsed the potatoes are subjected to frying in oil. Typically the frying may comprise a frying step of a minimum of 30 seconds at a minimum temperature of approximately 170 degrees centigrade.

After the frying step the potatoes are removed from the fryer and excess surface oil is removed by an air blower. The fried potatoes are then typically frozen to a temperature of minus 8 degrees centigrade or less.

### SUMMARY

It is an object of the present application to provide an improved process for preparing an oil-fried, batter-coated food article.

The present disclosure includes a process for producing a fried, batter-coated food article, the process comprising:
coating a food article with a batter comprising starch to obtain a batter-coated food article;
contacting the batter-coated food article with saturated steam to obtain a batter-coated food article having gelatinised starch;
frying the batter-coated food article having gelatinised starch to obtain the fried, batter-coated food article; and
optionally freezing the fried, batter-coated food article.

In an embodiment, the food article is a vegetable article.

In another embodiment, the process comprises:
coating a blanched vegetable article with a batter comprising starch to obtain a batter-coated vegetable article;
contacting the batter-coated vegetable article with saturated steam to obtain a batter-coated vegetable article having gelatinised starch;
frying the batter-coated vegetable article having gelatinised starch to obtain the fried, batter-coated vegetable article; and
optionally freezing the fried, batter-coated vegetable article.

In a further embodiment, the blanched vegetable article is prepared by steps comprising:
blanching a vegetable article under conditions to obtain a freshly blanched vegetable article;
contacting the freshly blanched vegetable article with a solution that inhibits surface discoloration of the blanched vegetable article to obtain a blanched, dipped vegetable article; and
partially drying the blanched, dipped vegetable article to obtain the blanched vegetable article.

In an embodiment, the process further comprises setting/dripping the batter-coated food article to remove excess batter prior to contacting the batter-coated food article with saturated steam. In another embodiment, the batter-coated food article is set/dripped for a time of about 20 seconds to about 25 seconds.

In an embodiment, the saturated steam is at a temperature of from about 95° C. to about 120° C. In another embodiment, the batter-coated food article contacts the saturated steam for at least about 10 seconds. In a further embodiment, the batter-coated food article contacts the saturated steam for a time of about 10 seconds to about 40 seconds.

In another embodiment, the batter-coated food article is moved through the saturated steam on a conveyor.

The present disclosure also includes a fried, batter-coated food article prepared according to a process for producing a fried, batter-coated food article of the present disclosure.

The present disclosure also includes a process for producing a fried starchy vegetable food article, the process comprising the steps of:
optionally processing a vegetable portion into a desired size and shape;
blanching the vegetable portion;
contacting the vegetable portion with a solution which reduces surface discolouration
drying the vegetable portion;
contacting the vegetable portion with a steam environment to gelatinise starch present upon the surface of the vegetable portion;
frying the vegetable portion in oil; and
optionally freezing the fried vegetable portion.

The present disclosure also includes a steam treatment apparatus for exposing a food product that is at least partially formed from a vegetable and coated in a batter coating containing starch, or a food product that is a portion of a starchy vegetable to steam, the apparatus comprising a steam generating arrangement, a conveyor and a hood surmounting the conveyor, the conveyor passing through the hood, wherein the steam generating arrangement contains a reservoir containing a body of water and a heating arrangement operable to boil the body of water to form saturated steam, the reservoir in fluid communication with the hood to convey the saturated steam to the hood and create a saturated steam environment therein.

In an embodiment, the heating arrangement comprises a submerged piping network through which steam can be circulated.

In another embodiment, the heating arrangement heats the body of water to generate saturated steam at a temperature of between 95 degrees centigrade and 120 degrees centigrade.

In an embodiment, the speed of the conveyor is such that the transit time for a food product through the steam vessel is at least 10 seconds. In another embodiment, the transit time is between 10 and 40 seconds.

In an embodiment, the conveyor comprises the product supporting surface and the product supporting surface of the conveyor is positioned between 200 mm and 1000 mm above the surface of the water contained within the reservoir.

In an embodiment, the product supporting surface of the conveyor is horizontal. In an alternative embodiment, the product supporting surface of the conveyor is inclined.

Other features and advantages of the present disclosure will become apparent from the following detailed description. It should be understood, however, that the detailed description and the specific examples while indicating embodiments of the disclosure are given by way of illustration only, since various changes and modifications within the spirit and scope of the disclosure will become apparent to those skilled in the art from this detailed description.

### BRIEF DESCRIPTION OF THE DRAWINGS

The present disclosure will now be described with reference to the accompanying drawings, in which:

FIG. 1 shows a schematic representation of a process of producing a fried, batter-coated potato article according to the prior art;

FIG. 2 shows a schematic representation of a process of producing a fried potato article according to the prior art;

FIG. 3 shows a schematic representation of a process of producing an oil fried, batter-coated food article according to an aspect of the present disclosure;

FIG. 4 shows a schematic representation of a process of producing an oil fried starchy vegetable food article according to another aspect of the present disclosure;

FIG. 5 shows a schematic representation of a process for producing a fried, batter-coated food article according to a further aspect of the present disclosure;

FIG. 6 shows a schematic representation of a steam treatment apparatus;

FIG. 7 shows a schematic representation of an alternative embodiment of a steam treatment apparatus;

FIG. 8 shows a schematic of a modified Burco boiler that was used as a source of steam in trials of the present disclosure;

FIGS. 9A and 9B show data from sensory testing of fried, batter-coated French fries produced according to a standard process (Test 1) in comparison to fried, batter-coated French fries produced according to an embodiment of a process of the present disclosure (Test 2);

FIG. 10 is a plot showing the finished oil content of fried, batter-coated French fries produced by a process for producing a fried, batter-coated French fry according to embodiments of a process of the present disclosure having a 15 second and 22 second set/drip belt time in comparison to fried, batter-coated French fries produced by a standard process (control);

FIG. 11 is a plot showing the moisture content of fried, batter-coated French fries produced by a process for producing a fried, batter-coated French fry according to an embodiment of a process of the present disclosure having a 22 second set/drip belt time in comparison to fried, batter-coated French fries produced by a standard process (control);

FIG. 12 is a plot showing the sum of drip off to a particular point in time as a function of drip time for three different embodiments of a process for producing fried, batter-coated French Fries of the present disclosure;

FIGS. 13A and 13B show data from sensory testing of fried, batter-coated French fries produced according to a standard process (Test 1) in comparison to fried, batter-coated French fries produced according to an embodiment of a process of the present disclosure (Test 2); and

FIG. 14 is a plot showing the sensory score as a function of Batter On Fries (BOF) for crispness (lower line) and flavor strength (upper line). The arrow indicates the degree to which an embodiment of a process of the present disclosure has improved batter efficiency.

### DETAILED DESCRIPTION

### I. Definitions

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

The term “native starch” as used herein refers to a starch extracted from a starch-bearing crop in its natural form, i.e. the starch has not been chemically, enzymatically and/or physically modified, and includes a starch extracted from a starch-bearing crop that has been bred and/or genetically engineered to have a different amylose content in its starch.

The term “modified starch” and the like as used herein refers to a starch that has been prepared by treating a native starch, for example chemically, enzymatically and/or physically treating a native starch. In an embodiment, the modified starch is a chemically modified starch that has been prepared by chemically treating a native starch. In an embodiment, the modified starch such as a chemically modified starch is substituted and/or cross-linked.

The term “substituted” as used herein in reference to a starch means that the starch has been modified via the addition of at least one type of blocking group to the starch polymer backbone.

The term “cross-linked” as used herein in reference to a starch means that the starch has been modified via the introduction of covalent bonds within the starch so that inter- and/or intramolecular bridges (i.e. cross-links) are formed between starch polymer backbones.

The term “excess batter” as used herein refers to batter that is not held in place on a food article such as a potato article by viscosity alone. It will be appreciated by a person skilled in the art that if the external forces on the batter exceed the viscosity then the batter will drip off regardless of whether the batter-coated food article is passed through air, steam or oil.

Certain terms which are used herein refer to items which may be known under more than one name in the English language. For example, a person skilled in the art would readily understand that the term “maize starch” as used herein refers to a starch which may also be known as “corn starch”.

### II. Processes

The processes for producing fried, batter-coated food articles such as fried, batter-coated French fries of the present disclosure have been shown to result in a reduction in the batter crumb contamination of the frying oil, with a consequent reduction in the degradation of the frying oil and a reduced need for the frying apparatuses to be emptied and cleaned. The single frying step reduces oil usage and reduces the footprint of the process machinery as only a single frying apparatus is required. Furthermore, the sealing of the batter in the steam environment prevents moisture migration into the batter from the blanched potato article during frying.

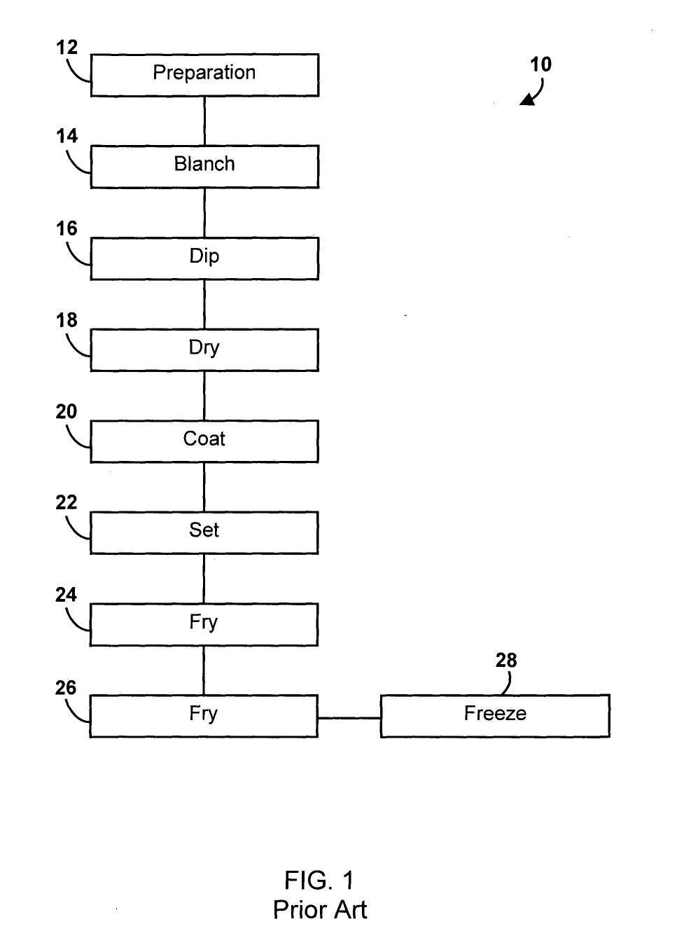

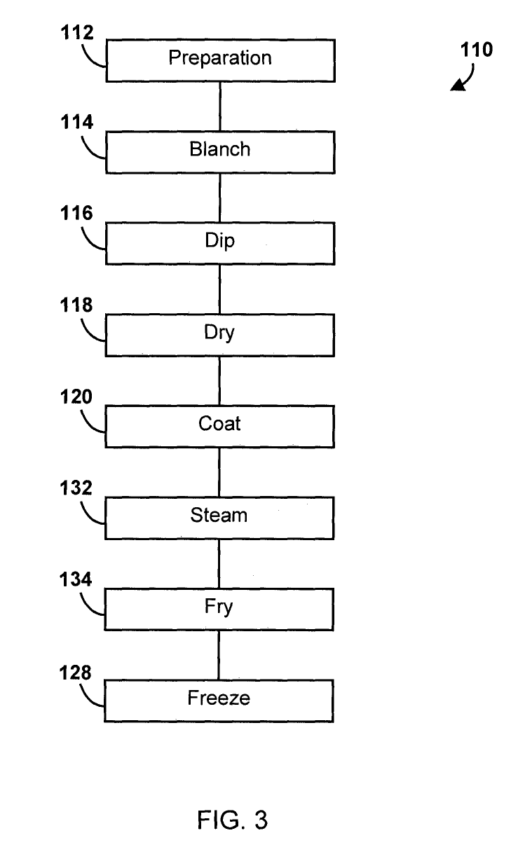

A process according to an aspect of the present disclosure is described with reference to the process steps, generally designated 110, which are shown in FIG. 3. The process is suitable for the production of an oil fried, batter-coated vegetable article, for example an oil fried, batter-coated potato article. The process steps generally similar to the process described with reference to FIG. 1 are identified with like reference numerals prefixed with a numeral 1. Examples of how the process 110 differs are that the setting step 22 is replaced with a steaming step 132, and that the two frying steps 24,26 are typically replaced by a single frying step 134.

Examples of typical batter compositions are listed herein. It will be appreciated by a person skilled in the art that this list is not exhaustive and other compositions may be used depending, for example upon the nature of the food article such as a potato article and the desired characteristics of the finished fried, batter-coated food article. The selection of a suitable batter composition can be made by a person skilled in the art. The batter typically comprises water, salt, seasoning, flour, starch and natural colouring. Optionally the batter may also include oil, stabiliser and dextrin.

The starch element of the batter composition optionally comprises one or more of the following starches: Native Corn/Maize, Modified Corn/Maize, Native Wheat, Modified Wheat, Native Rice, Modified Rice, Native Tapioca, Modified Tapioca, Native Sago, Modified Sago, Native High Amylose, Modified High Amylose, Native Waxy Maize, Modified Waxy Maize, Native Potato and Modified Potato.

The food article is optionally any food that is coated in a starch batter for frying. Examples of starch compositions are provided in Table 1.

After coating, the vegetable portions are contacted with steam. Looking firstly at the steaming step 132, the batter-coated potato article is passed through a steam environment after coating and before frying. The steam environment typically contains saturated steam which is at or only slightly above atmospheric pressure (e.g. at or slightly above 1 atm). This saturated steam typically contains water droplets suspended in the steam; i.e. the steam is wet saturated steam. For example, it will be appreciated by a person skilled in the art that wet saturated steam can exist in the region enclosed by the saturated water and dry saturated steam lines on a temperature enthalpy phase diagram for water/steam. For example, the wet saturated steam is in the region close to, optionally adjacent to the saturated water line in the region enclosed by the saturated water and dry saturated steam lines on a temperature enthalpy phase diagram for water/steam. The steam temperature is optionally in the region of 95° C. to 120° C. The time period during which the batter-coated potato article is retained in the steam environment will depend upon the batter composition but will typically be in the region of 10 to 40 seconds.

Optionally, the batter-coated potato article is moved through the steam environment on a conveyor which extends between the coating station and the fryer. Where a conveyor is employed, the steam environment may optionally be provided within a housing which surrounds, for example an existing setting conveyor extending between the coating station and a fryer. The housing may include or be connected to a water bath, optionally provided below the conveyor which can be heated in order to cause controlled boiling of the water. Heat may be provided by any appropriate means including, for example, electric elements or steam conduits which are immersed in the bath. The conveyor is typically surrounded with a shroud so as to retain steam and prevent the uncontrolled escape of the steam. Alternatively, saturated steam at 95° C. to 120° C. can be delivered into the unit from external generation sources such as but not limited to steam-water mixing systems.

Exposure to the steam environment causes gelatinisation of the starch component of the batter. This increases the robustness of the batter and results in better adhesion of the batter to the potato article. The batter in the saturated steam environment is, for example heat treated to a point in the phase transition where it has reached a temperature that allows the starch molecular order to change, causing a loss of molecular order in the starch and increased hydration of the starch macromolecules, optionally maximizing hydration of the starch for the particular temperature and pressure conditions.

As noted above, the gelatinised batter has better adhesion and cohesion and thus there is a reduction in the shedding of batter from the potato article when it is placed in an oil fryer. The increase in the amount of moisture retained by the batter coating prior to frying and the degree of gelatinisation of the batter coating achieved during steam treatment when compared to known processes means that employing only a single frying step is useful in processes of the present disclosure. This single frying step can be undertaken for a duration which is less than that of the combined time of a two step frying process described with reference to the prior art.

Some examples of batters tested using the methodology described herein are listed in Table 2 at the end of this disclosure. The batter-coated products are typically described with respect to potato for illustrative purposes. It will be understood by a person skilled in the art that the methodology of the process, and particularly the gelatinization of surface starch on a starchy vegetable product, is applicable to the batter coating of other vegetables and vegetable portions. The most common par-fried vegetable products are made from potatoes and the description herein primarily refers to potato products (such as French fries, potato chips, oven baked potatoes, rösti, potato crisps, potato cakes, potato sticks). The products are optionally from root vegetables, such as potatoes, cut into strips (e.g. longitudinal strips) or formed (e.g. extruded) into strips. It will be readily apparent to a person skilled in the art that parameters may be adapted depending on the type of potato variety used, since different varieties have different contents of sugars and other solids. It will also be readily apparent that one can adapt the potato methods and apparatus to other root vegetables. Other vegetables may be used, including, but not limited to, root vegetable products. Vegetable products include products made from root vegetables such as potatoes, yam, carrots and beets as well as sweet potatoes.

According to an aspect of the present disclosure there is provided a process of producing a fried, batter-coated food article, the food article comprising a vegetable portion, the process comprising:
blanching the vegetable portion;
drying the vegetable portion;
next coating the vegetable portion with a batter that comprises starch;
contacting the coated vegetable portion with saturated steam, the saturated steam gelatinising the starch in the batter; and
frying the coated vegetable portion in oil.

According to another aspect of the present disclosure there is provided a process of producing a fried, batter-coated food article, the food article comprising a vegetable portion, the process comprising:
optionally blanching the vegetable portion;
optionally drying the vegetable portion;
coating the vegetable portion with a batter that comprises starch;
contacting the coated vegetable portion with saturated steam, the saturated steam gelatinising the starch in the batter; and
frying the coated vegetable portion in oil.

The food article may comprise the vegetable portion only or it may comprise additional food components (such as non-vegetable components). Prior to coating, the food article is typically processed into a desired size and shape and dipped in a solution that prevents surface discolouration and dried. The batter is applied to the blanched vegetable portion and typically the blanching and coating steps are separate, with a drying step between them. The saturated steam typically forms a saturated steam environment (e.g. a region of steam, such as a cloud of steam) surrounding the vegetable portion or article. After the steam gelatinising step, the batter is transformed from a liquid to a gel and typically forms a continuous, gel layer over the vegetable or article (e.g. a flexible gelatinized layer coating the vegetable or article). Optionally, the fried, batter coated vegetable portion is frozen.

According to another aspect of the present disclosure there is provided a process of producing an oil fried, batter-coated food article, the food article comprising a vegetable portion, the process optionally comprising the steps of:
processing the vegetable portion into a desired size and shape;
blanching the vegetable portion;
contacting, optionally dipping, the vegetable portion in a solution that reduces surface discolouration;
drying the vegetable portion;
coating the vegetable portion with a batter which includes a starch component;
contacting the batter coated vegetable portion with saturated steam to gelatinise the starch component of the batter, for example, by passing the batter coated vegetable portion through the saturated steam, the saturated steam typically forming a saturated steam environment (e.g. a region of steam, such as a cloud of steam) surrounding the vegetable portion;
frying the batter coated vegetable portion in oil; and
freezing the fried, batter coated vegetable portion.

The present disclosure also includes a process of producing a batter coated food article, the food article comprising a vegetable portion, the process comprising the steps of:
optionally processing the vegetable portion into a desired size and shape;
blanching the vegetable portion;
contacting the vegetable portion with a solution that reduces surface discolouration;
next drying the vegetable portion;
next coating the vegetable portion with a batter which includes a starch component;
contacting the batter coated vegetable portion with saturated steam to gelatinise the starch component of the batter;
frying the batter coated vegetable portion in oil; and
optionally freezing the fried, batter coated vegetable portion.

The step of passing the coated vegetable portion through the saturated steam environment gelatinises the starch contained in the batter. This promotes both adhesion of the batter coating to the vegetable portion and cohesion of batter coating as a whole. The steam treatment seals and sets the batter, forming a sealed coating around the vegetable product. Frying is not used to set the batter, as in conventional processes. Conventional frying processes expel moisture from the batter then draw moisture from inside the product into the batter as the moisture originally in the batter is expelled. The processes of the present disclosure have already used steam to set the batter at the time of initiating frying. Advantageously, there will be reduced transfer of moisture from inside the vegetable into the steam-set batter during frying. The problem of crumbing is overcome. In the processes of the disclosure, frying does not set the batter but dehydrates and crisps the batter coating.

The saturated steam environment is optionally at a temperature of between 95° C. and 120° C. The batter-coated vegetable portion may remain in the saturated steam environment for a time sufficient to gelatinize starch contained in the batter, such as for at least 10 seconds. Optionally, the batter coated vegetable portion remains in the saturated steam environment for between 10 seconds and 40 seconds. The batter coated vegetable portion is optionally moved through the saturated steam environment on a conveyor.

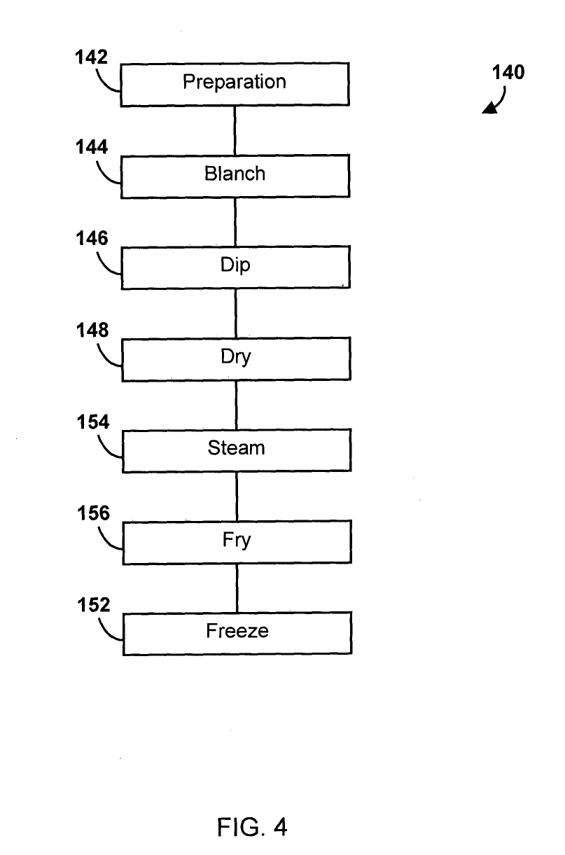

A process according to another aspect of the present disclosure is described with reference to the process steps, generally designated 140, which are shown in FIG. 4. The process is suitable for the production of an oil fried starchy vegetable food article, for example an oil fried potato food article. This process does not require a batter.

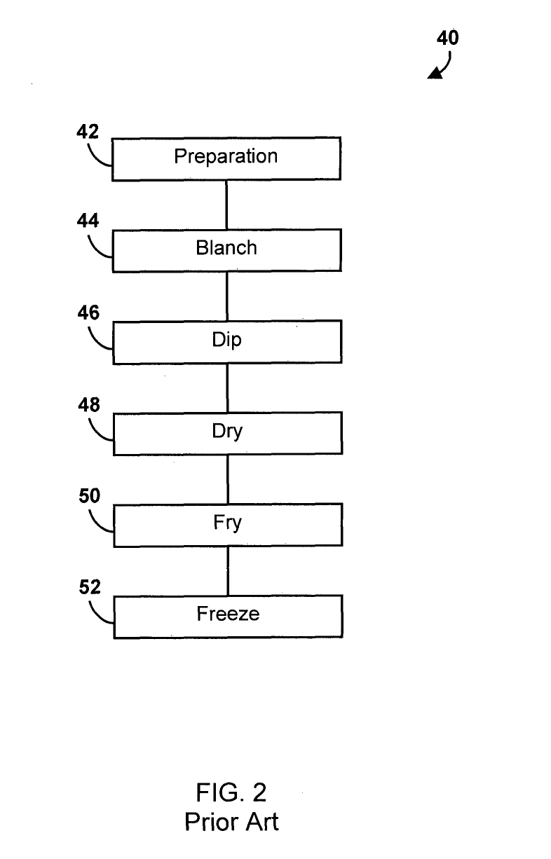

The process steps similar to the process described with reference to FIG. 2 are identified with like reference numerals prefixed with a 1. The process 140 differs, for example, in that a steaming step 154 is provided between the drying step 148 and the frying step 156.

In the steaming step 154, the potato article is passed through a steam environment after drying and before frying. The steam environment contains saturated steam which is at or only slightly above atmospheric pressure (e.g. 1 atm). The steam temperature may optionally be in the region of 95° C. to 120° C. The time period during which the potato article is retained in the steam environment will depend upon the size and shape of the article and the starch characteristics of the potato variety from which it is made. The time period may typically range from 10 to 40 seconds.

Typically, the potato article is moved through the steam environment on a conveyor which extends between the drying location and the fryer. Alternatively, multiple potato articles may be collected and batch processed in a steam environment. Where a conveyor is employed, the steam environment may optionally be provided within a housing which surrounds, for example an existing conveyor extending between the drying location and a fryer. The housing may include or be connected to a water bath provided below the conveyor which can be heated in order to cause controlled boiling of the water. Heat may be provided by any appropriate means including, for example, electric elements or steam conduits which are immersed in the bath. The conveyor is surmounted with a cover such as a shroud so as to prevent the uncontrolled escape of the steam. The shroud optionally forms a seal (e.g. containing some or all of the produced steam) around the conveyor. Alternatively, saturated steam at 95° C. to 120° C. can be delivered into the unit from external generation sources such as but not limited to steam-water mixing systems.

Exposure to the steam environment causes gelatinisation of starch present upon the surface of the potato article. The gelatinised starch produces a surface to the potato article after oil, frying which has improved crispness and texture. The steam environment provides moisture, and thus prevents the potato article from drying significantly as the starch gelatinises.

According to another aspect of the present disclosure there is provided a process of producing a fried starchy vegetable food article, the process comprising the steps of:
optionally processing a vegetable portion into a desired size and shape;
blanching the vegetable portion;
contacting, optionally dipping, the vegetable portion in a solution which prevents surface discolouration;
drying the vegetable portion;
contacting the vegetable portion with saturated steam to gelatinise starch present on the surface of the vegetable portion (e.g. native starch produced by the vegetable portion), optionally by passing the vegetable portion through a saturated steam environment;
frying the vegetable portion in oil; and
optionally freezing the fried vegetable portion.

The present disclosure also includes a process of producing a fried starchy vegetable food article, the process comprising the steps of:
optionally processing a vegetable portion into a desired size and shape;
blanching the vegetable portion;
contacting the vegetable portion in a solution which reduces surface discolouration;
drying the vegetable portion;
contacting the vegetable portion with a steam environment to gelatinise starch present upon the surface of the vegetable portion;
frying the vegetable portion in oil; and
optionally freezing the fried vegetable portion.

It will be appreciated by a person skilled in the art that the conditions selected for the steaming step are not typically useful to cook a vegetable portion, in contrast to the conditions selected, for example for a blanching step. The step of passing the vegetable portion through the saturated steam environment at least partially gelatinises starch present upon the surface of the vegetable portion. The starch present upon the surface of the vegetable portion is typically hydrated, for example from a prior blanching step. This improves surface crispness and texture of the vegetable portion after oil frying.

The saturated steam environment is optionally at a temperature of between 95° C. and 120° C., The vegetable portion may remain in the saturated steam environment for at least 10 seconds. The vegetable portion typically remains in the saturated steam environment for between 10 seconds and 40 seconds. The vegetable portion is typically moved through the saturated steam environment on a conveyor.

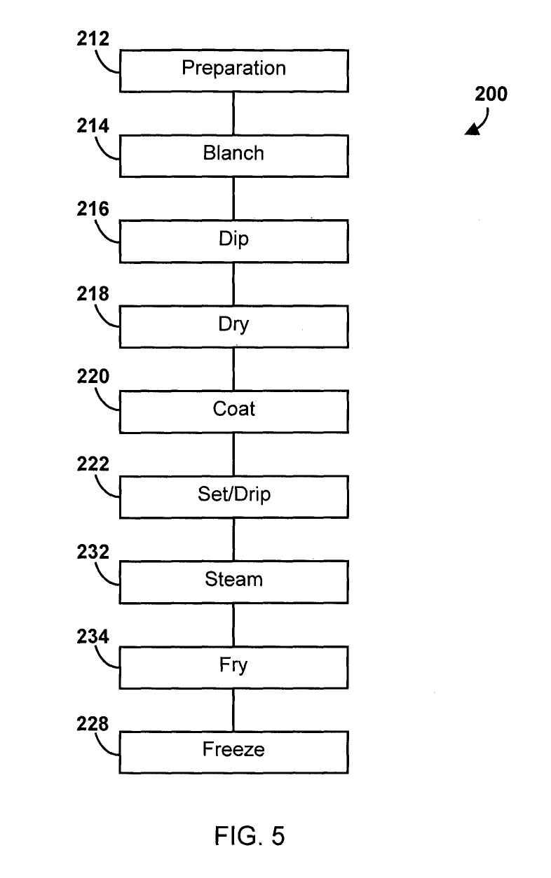

Another exemplary process flow diagram is shown in FIG. 5. The exemplified process 200 is a process for producing a fried, batter-coated food article such as a fried, batter-coated vegetable article, for example a fried, batter-coated potato article. Referring to FIG. 5, in the exemplified process 200, unprepared food articles (not shown) are prepared in a preparation step 212 to obtain food articles such as vegetable articles, for example potato articles (not shown). The food article is then optionally blanched in a blanching step 214, optionally dipped in a dipping step 216 and/or optionally partially dried in a drying step 218 prior to being coated with a batter comprising starch in coating step 220 to obtain a batter-coated food article (not shown). The batter-coated food article optionally undergoes a set/drip step 222 prior to being contacted with saturated steam in steaming step 232 to obtain a batter-coated food article having gelatinised starch (not shown). The batter-coated food article having gelatinised starch is then fried in a frying step 234 to obtain a fried, batter-coated food article such as a fried, batter-coated vegetable article, for example a fried, batter-coated potato article (not shown) which is optionally frozen in a freezing step 228. The process is typically described herein with respect to potatoes for illustrative purposes. The most common par-fried vegetable products are made from potatoes.

The operations carried out in the preparation step 212 will depend on the desired fried, batter-coated food article to be produced in the process. For example, where the fried, batter-coated food article is a fried, batter-coated potato article, preparation step 212 can include but is not limited to operations such as grading potatoes to select potatoes of a desired shape and/or size, washing the potatoes, for example to remove soil, peeling the potatoes to remove at least a portion of peel on the potatoes, optionally substantially all or all of the peel on the potatoes, pre-heating the potatoes, for example using a hot water bath and cutting and/or processing the potatoes to a desired shape and/or size. The selection of suitable operations to be carried out in preparation step 212 for a particular fried, batter-coated food article such as a fried, batter-coated vegetable article, for example a fried, batter-coated potato article can be made by a person skilled in the art. For example, if potato skin is to be retained on the fried, batter-coated potato article, the preparation step 212 includes washing the potatoes.

In an embodiment, the fried, batter-coated food article is a fried, batter-coated vegetable article. In another embodiment, the fried, batter-coated vegetable article is a fried, batter-coated onion article such as a fried, batter-coated onion ring. In a further embodiment, the fried, batter-coated vegetable article optionally further comprises additional food components such as non-vegetable components. In another embodiment, the fried, batter-coated food article is a fried, batter-coated root vegetable article such as a yam, parsnip, carrot and/or beet. In a further embodiment, the fried, batter-coated food article is a fried, batter-coated tuberous root vegetable article.

It is an embodiment that the fried, batter-coated food article is a fried, batter-coated potato article. In an embodiment, the fried, batter-coated potato article is prepared from a potato article comprising at least a portion of any processing variety of potato or any processing variety of sweet potato. For example, the potatoes used in a process for preparing fried, batter-coated potato articles of the present disclosure can be but are not limited to, Maris Piper, Pentland Dell, Markies, Shepody, Premiere, Russet Burbank, Bintje, Innovator and Morene. It will be readily apparent that parameters may be adapted depending on the type of potato variety used, since different varieties can, for example have different contents of sugars and other solids, and depending on whether a potato or a sweet potato is used in the process.

In an embodiment, the food article is a potato article, the unprepared food article is a potato and in preparation step 212, the potatoes are cut into a desired shape and/or size to obtain the potato articles. For example, if the process for preparing fried, batter-coated food articles is a process for preparing fried, batter-coated French fries or fried, batter-coated sweet potato fries, the potatoes can be cut into shapes that are commonly referred to in the art as sticks or strips, for example longitudinal sticks or strips. The selection of a suitable cut of potato for a fried, batter-coated French fry or a fried, batter-coated sweet potato fry can be made by a person skilled in the art. Alternatively, the potatoes are cut into, for example but not limited to halves, quarters, wedges, cubes, slices or a novelty cut such as but not limited to a spiral shape. Alternatively, the potatoes are not cut after washing and optionally peeling, and the potato articles comprise the whole, washed and optionally peeled potatoes. Accordingly, in an embodiment, the potato article is selected from a whole potato, a potato half, a potato quarter, a potato wedge, a potato strip or stick, a potato cube, a potato slice and a novelty cut of potato such as but not limited to a spiral shape. In another embodiment, the potato article is selected from a potato wedge and a potato strip or stick. In a further embodiment, the potato article is a potato strip or stick. In an embodiment, the potato article is a 9/32 to 19/64 inch cut for shoestring cut French fries or a 3/16 inch to 1.5 inch cut for square cut French fries. Optionally, the potato articles are sliced for 9/16 or 19/64 inch cut French fries.

In optional blanching step 214, enzymes can be inactivated and/or sugars removed from the surface of food articles such as potato articles which, if not removed may cause discoloration of the potato articles. In the blanching step 214, food articles such as potato articles are blanched for a time and at a temperature under conditions to obtain the blanched food articles such as potato articles. The conditions to obtain the blanched potato articles may vary, for example based on the size and/or the shape of the potato articles. The selection of suitable conditions to obtain the desired blanched potato articles can be made by a person skilled in the art.

In an embodiment, the food articles such as potato articles are blanched by immersing the food articles such as potato articles in heated water, for example in a hot water bath for a time and at a temperature to obtain the blanched food articles such as blanched potato articles. In another embodiment, the time to obtain the blanched potato articles is from about 8 to about 20 minutes at a temperature of from about 70° C. to about 90° C. Alternatively, the food articles such as potato articles are blanched by deluging the food articles such as potato articles under hot water sprays for a time and at a temperature to obtain the blanched potato articles. For example, the time to obtain the blanched food articles such as blanched potato articles is from about 8 to about 20 minutes at a temperature of about 70° C. to about 90° C. Alternatively, the food articles such as potato articles are blanched by exposing the food articles such as potato articles to heated steam for a time and at a temperature to obtain the blanched food articles such as blanched potato articles. In an embodiment, the time to obtain the blanched potato articles is from about 5 minutes to about 10 minutes at a temperature of about 100° C. It will be appreciated by a person skilled in the art that other alternative methods of blanching may be used such as but not limited to pulsed electric field (PEF).

Alternatively, it will be appreciated by a person skilled in the art that certain food articles, for example certain vegetable articles such as but not limited to zucchini articles, baby sweetcorn articles and onion articles, for example onion rings may not require a blanching step.

It will be appreciated by a person skilled in the art that certain blanched food articles such as potato articles may undergo a discoloration that is commonly referred to as after-cooking darkening (ACD) due to a reaction comprising the oxidation of an iron-containing complex. Accordingly, in the optional dipping step 216, the blanched potato articles are contacted, for example immersed in a solution that inhibits discoloration of the potato articles due to iron oxidation. The selection of a suitable solution that inhibits discoloration of the potato articles due to iron oxidation can be made by a person skilled in the art. In an embodiment, the solution that inhibits discoloration of the potato articles due to iron oxidation comprises sodium acid pyrophosphate (SAPP). In another embodiment, the solution that inhibits discoloration of the potato articles due to iron oxidation comprises sodium acid pyrophosphate (SAPP) in an amount of about 0.6 wt % to about 1 wt %.

In the optional drying step 218, the blanched, optionally dipped potato articles are partially dried under conditions to obtain a desired moisture reduction in the blanched potato articles. Partially drying the potato articles equilibrates the moisture content of the blanched, optionally dipped potato articles, controlling the moisture loss in the fryer and/or creates a thin, partially gelatinized layer of starch on the surface of the blanched, optionally dipped potato articles. It will be appreciated that this surface layer will, for example allow better adhesion of a batter to the potato article. The conditions to obtain a desired moisture reduction in the potato articles may vary, for example based on the size and the shape of the blanched, optionally dipped potato articles. The selection of suitable conditions can be made by a person skilled in the art. The conditions are generally plant-specific and are controlled with relative humidity (RH %). In an embodiment, the drying step 218 comprises placing the blanched, optionally dipped potato articles in an elevated temperature environment such as a drying oven at a temperature and for a time to obtain the desired moisture reduction. In another embodiment, the time to obtain the desired moisture reduction is from about 5 minutes to about 15 minutes at a temperature of about 30° C. to about 70° C. Alternatively, the drying step 218 comprises drying the blanched, optionally dipped potato articles at ambient temperature for a time to obtain the desired moisture reduction. It will be appreciated that dry losses for different food articles such as vegetable articles may vary, for example from about 2 wt % to about 15 wt % and the selection of a suitable dry loss for a particular food article such as a vegetable article can be made by a person skilled in the art.

In an embodiment, the vegetable article is a potato article and the minimum moisture reduction is about 2 wt %, based on the total weight of the potato article. It is an embodiment of the present disclosure that the vegetable article is a potato article and the moisture reduction is about 5 wt % to about 10 wt %, based on the total weight of the potato article. In another embodiment, the vegetable article is a potato chunk (for example, a roast potato) and the minimum moisture reduction is about 2 wt %, based on the total weight of the potato chunk. In a further embodiment, the vegetable article is a potato strip or stick, for example a 9/16 cut potato strip or stick and the minimum moisture reduction is about 3 wt %, based on the total weight of the 9/16 cut potato strip or stick. In another embodiment, the vegetable article is a potato strip or stick and the moisture reduction is about 8 wt % to about 10 wt %, based on the total weight of the potato strip or stick.

Alternatively, it will be appreciated by a person skilled in the art that certain food articles, for example certain vegetable articles such as but not limited to zucchini articles, sweetcorn articles and onion articles, for example onion rings may not require a drying step.

In coating step 220, the food article such as the blanched, optionally dipped, optionally partially dried potato article is coated with a batter comprising starch to obtain the batter-coated food article such as the batter-coated potato article. Conditions for coating a food article such as a blanched, optionally dipped, optionally partially dried potato article are known in the art, for example conditions that comprise conventional coating equipment. In an embodiment, the conditions comprise using, for example but not limited to a waterfall enrober, a submerger enrober, spraying or dipping. The selection of suitable conditions for coating a food article such as a blanched, optionally dipped, optionally partially dried potato article can be made by a person skilled in the art. In an embodiment of the present disclosure, the process comprises coating the food article such as the blanched, optionally dipped, optionally partially dried potato article with a submerger enrober such as a submerger enrober with an overflow curtain. The overflow curtain is useful, for example as it can minimize waste and/or drip time. Optionally, the batter-coated potato article is passed before a blower subsequent to the coating step 220. The blower can remove, for example at least a portion of excess batter. It will be appreciated by a person skilled in the art that if a blower is not used to remove excess batter after coating step 220, a longer time for a set/drip step may be used, for example to obtain the desired removal of excess batter for a particular batter-coated food article such as a batter-coated potato article.

The composition of the batter comprising starch may vary, for example on the size and/or shape of the food article such as a potato article to be coated and/or the desired properties of the finished fried, batter-coated food article such as the fried, batter-coated potato article. The selection of a suitable batter comprising starch for a particular process of the present disclosure can be made by a person skilled in the art. For example, a batter comprising starch having a useful viscosity and/or solids content for a particular finished fried, batter-coated food article such as a fried, batter-coated potato article, for example a fried, batter-coated French fry produced by a process of the present disclosure can be made by a person skilled in the art, for example, with reference to the present disclosure.

In an embodiment, the batter comprising starch comprises a native starch, a modified starch or mixtures thereof. In another embodiment, the batter comprising starch comprises a native starch. In a further embodiment, the batter comprising starch comprises a modified starch. In an embodiment, the modified starch is a modified potato starch, a modified maize starch, or a mixture of a modified tapioca starch and a modified high amylose maize starch. In another embodiment, the modified starch is a modified maize starch. It is an embodiment that the batter comprising starch comprises a native maize starch, a modified maize starch, a native wheat starch, a modified wheat starch, a native rice starch, a modified rice starch, a native tapioca starch, a modified tapioca starch, a native sago starch, a modified sago starch, a native high amylose starch, a modified high amylose starch, a native waxy maize starch, a modified waxy maize starch, a native potato starch, a modified potato starch or mixtures thereof. In another embodiment, the batter comprising starch is selected from any of the specific batters disclosed herein, for example those tested in the studies of the present disclosure. Table 2 lists batters that were tested in the studies of the present disclosure.

In an embodiment, the batter comprising starch optionally comprises one or more flours. In an embodiment, the flour is selected from one or more of wheat flour such as heat-treated wheat flour and/or biscuit wheat flour and rice flour. It will be appreciated by a person skilled in the art that flours may be useful for color blending and/or final crispness in a fried, batter-coated food article. Flours made from ancient grains such as quinoa and spelt may also be useful in the batter comprising starch used in the processes for producing a fried, batter-coated food article of the present disclosure.

In another embodiment, the batter comprising starch optionally comprises a salt suitable for use in food applications. It will be appreciated by a person skilled in the art that regulatory agencies may set limits on the amount and/or types of salt used in foods. It will also be appreciated that salt may contribute, for example to flavor, to starch order, and may hold onto some available moisture in a coating, thereby lowering a starch gelatinization temperature. Accordingly, in an embodiment the salt comprises, consists essentially of or consists of one or more of sodium chloride (NaCl), potassium chloride (KCl) and calcium chloride (CaCl₂). In another embodiment, the salt comprises, consists essentially of or consists of sodium chloride. In a further embodiment, the batter comprising starch comprises a salt such as sodium chloride in an amount of about 0 wt % to about 10 wt %, based on the total weight of the batter. In another embodiment, the batter comprising starch comprises a salt such as sodium chloride in an amount of about 5 wt % to about 10 wt %, based on the total weight of the batter. In a further embodiment, the batter comprising starch comprises a salt such as sodium chloride in an amount of about 0.5 wt % to about 5 wt %, based on the total weight of the batter.

In another embodiment of the present disclosure, the batter comprising starch optionally comprises a stabilizer, for example an agent that assists in keeping starches in suspension in their cold state. It will be appreciated that such an agent is useful for example, for processing. The selection of a suitable stabilizer, for example, the agent that assists in keeping starches in suspension in their cold state for a particular batter comprising starch will depend, for example, on factors such as cost and/or the desired viscosity of the batter comprising starch and can be made by a person skilled in the art. In an embodiment, the stabilizer, for example the agent that assists in keeping starches in suspension in their cold state comprises, consists essentially of or consists of xanthan gum. In an embodiment, the batter comprising starch comprises xanthan gum in an amount of from about 0 wt % to about 10 wt %, 0 wt % to about 5 wt % or about 0 wt % to about 1 wt %, based on the total weight of the batter. In another embodiment, the batter comprising starch comprises xanthan gum in an amount of less than about 10 wt %, less than about 5 wt % or less than about 1 wt %, based on the total weight of the batter. In another embodiment, the xanthan gum is present in an amount of from about 0.01 wt % to about 1 wt %, based on the total weight of the batter. In a further embodiment, the xanthan gum is present in an amount of from about 0.025 wt % to about 0.1 wt %, based on the total weight of the batter.

In an embodiment, the batter comprising starch optionally comprises a coloring agent. In an embodiment, the coloring agent comprises, consists essentially of or consists of paprika extract (also known as paprika oleoresin) and/or turmeric extract. In another embodiment, the coloring agent comprises, consists essentially of or consists of paprika extract and turmeric extract. In another embodiment, the coloring agent comprises, consists essentially of or consists of paprika extract. In another embodiment, the coloring agent comprises, consists essentially of or consists of turmeric extract. In an embodiment, the batter comprising starch comprises turmeric extract in an amount of from about 0 wt % to about 10 wt %, about 0 wt % to about 5 wt % or about 0 wt % to about 1 wt %, based on the total weight of the batter. In another embodiment, the batter comprising starch comprises turmeric extract in an amount of less than about 10 wt %, less than about 5 wt % or less than about 1 wt %, based on the total weight of the batter. In another embodiment, the batter comprising starch comprises turmeric extract in an amount of from about 0.025 wt % to about 5 wt %, about 0.05 wt % to about 2.5 wt % or about 0.1 wt % to about 1 wt %, based on the total weight of the batter. In another embodiment, the batter comprising starch comprises paprika extract in an amount of from about 0 wt % to about 10 wt %, about 0 wt % to about 5 wt % or about 0 wt % to about 1 wt %, based on the total weight of the batter. In another embodiment, the batter comprising starch comprises paprika extract in an amount of less than about 10 wt %, less than about 5 wt % or less than about 1 wt %, based on the total weight of the batter. In another embodiment, the batter comprising starch comprises paprika extract in an amount of from about 0.025 wt % to about 5 wt %, about 0.05 wt % to about 2.5 wt % or about 0.1 wt % to about 1 wt %, based on the total weight of the batter. Coloring agents such as paprika extract and turmeric extract are available, for example from commercial sources.

In an embodiment, the batter comprising starch optionally comprises a dextrin. It will be appreciated by a person skilled in the art that dextrins are useful, for example for texture such as to form layers and/or to create structure and/or crispness in a finished fried, batter-coated food article such as a fried, batter-coated potato article, for example a fried, batter-coated French fry. In an embodiment, the dextrin is selected from a potato dextrin, a tapioca dextrin, a corn dextrin and mixtures thereof. In an embodiment, the batter comprising starch comprises a dextrin in an amount of from about 0 wt % to about 20 wt %, about 5 wt % to about 20 wt % or about 5 wt % to about 10 wt %, based on the total weight of the batter.

In another embodiment of the present disclosure, the batter comprising starch optionally comprises a raising agent. It will be appreciated by a person skilled in the art that raising agents are useful, for example for texture such as to form layers and/or to create structure and/or crispness in a finished fried, batter-coated food article such as a fried, batter-coated potato article, for example a fried, batter-coated French fry. In an embodiment, the raising agent is selected from an E450 raising agent such as a diphosphate, disodium phosphate or SAPP or an E500 raising agent such as sodium carbonate. The selection of a suitable raising agent for a particular batter comprising starch for use in a process of the present disclosure can be made by a person skilled in the art. In an embodiment, the batter comprising starch comprises a raising agent in an amount of from about 0 wt % to about 10 wt %, about 0.1 wt % to about 5 wt % or about 0.25 wt % to about 1 wt %, based on the total weight of the batter. In another embodiment, the batter comprising starch comprises a raising agent in an amount of less than about 10 wt %, less than about 5 wt % or less than about 1 wt %, based on the total weight of the batter.

In an embodiment, the batter comprising starch optionally comprises seasoning. In another embodiment, the seasoning is selected from herbs, spices, onion, garlic, chili, other natural flavorings and mixtures thereof. In an embodiment, the batter comprising starch comprises seasoning in an amount of from about 0 wt % to about 30 wt %, about 5 wt % to about 30 wt % or about 1 wt % to about 15 wt %, based on the total weight of the batter.

In an embodiment, the batter comprising starch optionally comprises vegetable oil. In another embodiment, the vegetable oil is selected from one or more of sunflower oil and palm oil such as sprayed palm oil or hardened palm oil. In an embodiment, the batter comprising starch comprises vegetable oil in an amount of from about 0 wt % to about 10 wt %, about 0.1 wt % to about 5 wt % or about 0.25 wt % to about 1 wt %, based on the total weight of the batter. In another embodiment, the batter comprising starch comprises vegetable oil in an amount of less than about 10 wt %, less than about 5 wt % or less than about 1 wt %, based on the total weight of the batter.

In an embodiment, the batter comprising starch optionally comprises an anti-caking agent such as silicon dioxide in a fine powder form. In an embodiment, the batter comprising starch comprises silicon dioxide in an amount of less than about 1 wt % or less than about 0.1 wt % on a dry weight basis. In another embodiment, the batter comprising starch comprises from about 0.01 wt % to about 0.1 wt % silicon dioxide.

In an embodiment, the batter comprising starch comprises, consists of or consists essentially of water (30-80%), wheat flour (35-65%), rice flour (10-20%), potato dextrin (5-20%) and modified starch (2-10%). In another embodiment, the batter comprising starch comprises, consists essentially of or consists of water (30-80%), wheat and rice flour (40-85%), dextrin (5-30%), salt (0-10%), modified starch (0-10%), color (turmeric extract, paprika extract; 0-10%) and vegetable oil (0-10%).

In an embodiment, the batter comprising starch comprises, consists essentially of or consists of water (30-80%), wheat flour (25-35%), rice flour (5-10%), salt (0-10%), maize starch (5-10%), a blend of modified maize starch and tapioca dextrin (10-20%), color (0-10%) and vegetable oil (0-10%).

In an embodiment, the batter comprising starch comprises, consists essentially of or consists of water (30-80%), modified starch (30-50%), rice flour (5-20%), wheat starch (5-20%) and potato dextrin (5-20%). In another embodiment, the batter comprising starch comprises, consists essentially of or consists of water (30-80%), modified starch (30-70%), rice flour (5-30%), starch (5-30%), dextrin (5-30%), salt (0-10%), raising agents (E450, E500; 0-10%) and stabilizer (xanthan gum; 0-10%).

In an embodiment, the batter comprising starch comprises, consists essentially of or consists of water (30-80%), wheat flour (40-65%), wheat starch (10-30%) and seasoning (5-30%). In another embodiment, the batter comprising starch comprises, consists essentially of or consists of water (30-80%), wheat flour (30-85%), wheat starch (5-30%), seasoning (5-30%), salt (0-10%), color (paprika extract; 0-10%) and vegetable oil (0-10%).

In an embodiment, the batter comprising starch comprises, consists essentially of or consists of water (30-80%), wheat flour (40-65%), wheat starch (5-30%), seasoning (1-15%) and salt (1-15%). In another embodiment, the batter comprising starch comprises, consists essentially of or consists of water (30-80%), wheat flour (30-65%), wheat starch (5-30%), salt (1-15%), seasoning (1-15%), color (paprika extract; 0-10%) and vegetable oil (0-10%).

In an embodiment, the batter comprising starch comprises, consists essentially of or consists of water (30-80%), wheat flour (35-65%), rice flour (10-20%), modified starch (2-10%), salt (0-10%) and maize starch (0-10%). In another embodiment, the batter comprising starch comprises, consists essentially of or consists of water (35-80%), wheat and rice flour (35-80%), modified starch (10-45%), salt (0-10%), starch (0-10%), color (turmeric extract, paprika extract; 0-10%) and vegetable oil (0-10%).

In an embodiment, the batter comprising starch comprises, consists essentially of or consists of water (30-80%), modified starch (50-70%), rice flour (5-20%) and salt (0-10%). In another embodiment, the batter comprising starch comprises, consists essentially of or consists of water (35-80%), modified starch (50-90%), rice flour (0-30%), salt (0-10%) and stabilizer (xanthan gum; 0-10%).

In an embodiment, the batter comprising starch comprises, consists essentially of or consists of water (40.00 wt %), wheat flour (30.00 wt %), rice flour (15.00 wt %), dextrin (8.00 wt %), salt (2.90 wt %), modified starch (4.00 wt %), color extracts (paprika and turmeric; 0.05 wt %) and vegetable oil (0.05 wt %).

In another embodiment, the batter comprising starch comprises, consists essentially of or consists of water (40.00 wt %), modified potato starch (33.40 wt %), rice flour (9.00 wt %), maize starch (8.00 wt %), dextrin (6.00 wt %), salt (2.95 wt %), raising agents (E450, E500; 0.60 wt %) and stabilizer (xanthan gum; 0.05 wt %).

In another embodiment, the batter comprising starch comprises, consists essentially of or consists of water (36.00 wt %), wheat flour (31.40 wt %), wheat starch (19.59 wt %), salt (1.00 wt %), seasoning (12.00 wt %), color extracts (paprika and turmeric; 0.05 wt %) and vegetable oil (0.05 wt %).

In another embodiment, the batter comprising starch comprises, consists essentially of or consists of water (36.00 wt %), wheat flour (35.00 wt %), wheat starch (19.59 wt %), salt (1.40 wt %), seasoning (8.00 wt %), color extracts (paprika and turmeric; 0.05 wt %) and vegetable oil (0.05 wt %).

In another embodiment, the batter comprising starch comprises, consists essentially of or consists of water (38.00 wt %), wheat flour (30.69 wt %), rice flour (6.95 wt %), modified starch (13.50 wt %), salt (3.91 wt %), maize starch (6.94 wt %), color extracts (paprika and turmeric; 0.05 wt %) and vegetable oil (0.05 wt %).

In another embodiment, the batter comprising starch comprises, consists essentially of or consists of water (38.00 wt %), modified starch (55.00 wt %), rice flour (4.00 wt %), salt (2.95 wt %) and stabilizer (xanthan gum; 0.05 wt %).

A person skilled in the art would readily understand how to prepare a batter comprising starch for use in a process of the present disclosure. For example, the dry ingredients of the batter comprising starch are mixed with water according to proportions described in the present disclosure.

In the optional set/drip step 222, the batter-coated food articles such as the batter-coated potato articles are set/dripped under conditions to remove excess batter. It will be appreciated by a person skilled in the art that in optional set/drip step 222, adherence of the batter coating to starchy food articles such as but not limited to potato articles will also occur whereas the batter-coating will not generally adhere to non-starchy food articles such as but not limited to onion articles, for example onion rings. Conditions to remove excess batter from the food article such as a potato article may vary, for example based on the shape, size and/or surface area of the food article such as a potato article. In an embodiment, the conditions to obtain the desired removal of excess batter comprise setting/dripping the batter-coated food article such as a potato article for a time and at a temperature to obtain the desired removal of excess batter. In an embodiment, the food article is a potato article such as a potato strip or stick and the batter-coated potato article such as the batter-coated potato strip or stick is set/dripped for a time of at least about 5 seconds, for example about 5 seconds to about 30 seconds, about 15 seconds to about 25 seconds or about 20 seconds to about 25 seconds. In an embodiment, the temperature is an ambient temperature, for example from about 18° C. to about 25° C. In an embodiment, the conditions to obtain the desired removal of excess batter comprise conveying the batter-coated food articles such as potato articles from a batter-coating location to a steaming location in the process of the present disclosure at an ambient temperature, for example from about 18° C. to about 25° C., for example on a set/drip belt for a time of at least about 5 seconds, for example about 5 seconds to about 30 seconds, about 15 seconds to about 25 seconds or about 20 seconds to about 25 seconds. In an embodiment, the excess batter coating that is removed is recycled, for example back into the process.

In an embodiment of the present disclosure, the batter pick-up is from about 5 wt % to about 20 wt %. It will be appreciated that a useful batter pick-up for a particular fried, batter-coated food article such as a fried, batter-coated potato article may depend, for example on the cut size of a potato article such as a potato strip or stick. In an embodiment of the present disclosure, the potato article is an about 9/16 cut potato strip or stick that is coated with a batter comprising starch under conditions to obtain a batter-coated 9/16 cut potato strip or stick having a batter pick-up of about 9 wt % to about 11 wt % (measured after set/drip step 222, if the process comprises a set/drip step) based on the total weight of the batter-coated 9/16 cut potato strip or stick. In another embodiment, the batter-coated potato article is a batter-coated 9/16 cut potato strip or stick having a batter pick-up of about 10 wt % (measured after set/drip step 222, if the process comprises a set/drip step) based on the total weight of the batter-coated 9/16 cut potato strip or stick. In a further embodiment of the present disclosure, the potato article is an about 19/64 cut potato strip or stick that is coated with a batter comprising starch under conditions to obtain a batter-coated 19/64 cut potato strip or stick having a batter pick-up of about 16.5 wt % to about 18.5 wt % (measured after set/drip step 222, if the process comprises a set/drip step) based on the total weight of the batter-coated 19/64 cut potato strip or stick. In another embodiment, the batter-coated potato article is a batter-coated 19/64 cut potato strip or stick having a batter pick-up of about 17.5 wt % (measured after set/drip step 222, if the process comprises a set/drip step) based on the total weight of the batter-coated 19/64 cut potato strip or stick. The selection of a suitable batter pick up for a particular process of the present disclosure can be made by a person skilled in the art. The processes of the present disclosure are useful to prepare a food article such as a potato article having a particular performance with a lower batter pick-up than a similar food article such as a potato article prepared by a standard process not comprising a steaming step. Having a lower batter pick-up for a particular performance of a food article such as a potato article is useful, for example as it may lower costs and/or reduce the amount of water introduced into the fryer, for example reducing the potential breakdown of oil. For example, it will be appreciated by a person skilled in the art that batter comprises a significant amount of water, for example about 60 wt % water which, when introduced into a fryer, can cause hydrolysis of the oil.

In the steam step 232, the batter-coated food article such as a batter-coated potato article is contacted with saturated steam to obtain a batter-coated food article having gelatinized starch. This saturated steam typically contains water droplets suspended in the steam; i.e. the steam is wet saturated steam. It will be appreciated by a person skilled in the art that the conditions selected for the steaming step 232 are not typically useful to cook the food article, in contrast to the conditions selected, for example for a blanching step. In an embodiment, the saturated steam has a temperature of about 95° C. to about 120° C. In another embodiment, the saturated steam has a temperature of about 100° C. In another embodiment, the batter-coated food article such as a batter-coated potato article is contacted with the saturated steam for at least about 10 seconds. In another embodiment, the batter-coated food article such as a batter-coated potato article is contacted with steam for a time of about 10 seconds to about 40 seconds. In another embodiment, the batter-coated food article such as a batter-coated potato article is contacted with steam for a time of about 18 seconds. In another embodiment, the batter-coated food article such as a batter-coated potato article is moved through the saturated steam on a conveyor.

In an embodiment of the present disclosure, a steam treatment apparatus of the present disclosure is used to contact the batter-coated food article such as a batter-coated potato article with the saturated steam. For example, the steam treatment apparatus comprises a steam generating arrangement, a conveyor and a hood surmounting the conveyor, the conveyor passing through the hood. For example, the steam generating arrangement can comprise a reservoir containing a body of water to form saturated steam, the reservoir in fluid communication with the hood to convey the saturated steam to the hood and create a saturated steam environment therein.

Optionally, the steam generating arrangement comprises a unit which mixes steam and water to generate saturated steam, for example at a temperature of from about 95° C. to about 120° C., for example about 100° C.

Optionally, the steam generating arrangement comprises a water trap arrangement of cooled water to deliver saturated steam, for example at a temperature of from about 95° C. to about 120° C., for example about 100° C., for example as a regulated volume.

Optionally, the steam generating arrangement comprises a vessel, and superheated and saturated steam is passed through the bottom and/or top of the vessel into condensing steam/water so that the steam that reaches the conveyor is fully saturated and has, for example a temperature of from about 95° C. to about 120° C., for example about 100° C.

In the frying step 234, the batter-coated food article such as a batter-coated potato article having gelatinized starch is fried in oil under conditions to obtain the fried, batter-coated food article such as the fried, batter-coated potato article. The conditions to obtain the fried, batter-coated potato article may vary, for example based on the size and shape of the potato article. The selection of suitable conditions to obtain the desired fried, batter-coated potato article can be made by a person skilled in the art. In an embodiment of the processes of the present disclosure, the step of frying comprises two steps. For example, the batter-coated potato article can be fried in a two stage fryer under conditions to obtain the fried, batter-coated potato article. In an embodiment, the step of frying comprises one step. It will be appreciated by a person skilled in the art that this single frying step can be undertaken for a duration which is less than that of the combined time of a two-step frying process described with reference to the prior art.

In an embodiment, the step of frying comprises par-frying the batter-coated potato article to obtain a par-fried, batter-coated potato article.

In another embodiment, the step of frying comprises par-frying the batter-coated potato article in one step under conditions to obtain the par-fried, batter-coated potato article. In an embodiment, the par-fried, batter-coated potato article is a par-fried, batter-coated 9/16 cut French fry, and the conditions to obtain the par-fried, batter-coated 9/16 cut French fry comprise frying a batter-coated 9/16 cut French fry in a suitable oil at a temperature of about 175° C. to about 185° C. for a time of about 60 seconds to about 70 seconds. In another embodiment, the par-fried, batter-coated potato article is a par-fried, batter-coated 9/16 cut French fry, and the conditions to obtain the par-fried, batter-coated 9/16 cut French fry comprise frying a batter-coated 9/16 cut French fry in a suitable oil at a temperature of about 185° C. for a time of about 60 seconds.

In a further embodiment, the step of frying comprises par-frying the batter-coated potato article in a two stage fryer under conditions to obtain the par-fried, batter-coated potato article. In an embodiment, the par-fried, batter-coated potato article is a par-fried, batter-coated 9/16 cut French fry, and the conditions to obtain the par-fried, batter-coated 9/16 cut French fry comprise frying a batter-coated 9/16 cut French fry in a suitable oil for a first stage at a minimum temperature of about 168° C. for a time of about 15 seconds to about 20 seconds followed by a second stage at a minimum temperature of about 178° C. for a time of about 65 seconds to about 70 seconds.

Oils used to fry batter-coated food articles such as batter-coated potato articles are known in the art and include without limitation, palm oil, sunflower oil, rapeseed oil, canola oil such as non-hydrogenated canola oil and vegetable oil blends. In an embodiment, the oil used in the step of frying comprises, consists essentially of or consists of sunflower oil, rapeseed oil, non-hydrogenated canola oil or a vegetable oil blend. In another embodiment, the oil used in the step of frying comprises, consists essentially of or consists of rapeseed oil, sunflower oil or non-hydrogenated canola oil.

Subsequent to the frying step 234, the fried, batter-coated food article such as the fried, batter-coated potato article is removed from the fryer and optionally excess surface oil is removed, for example using an air blower. In an embodiment, the optional step of removing excess surface oil from the fried, batter-coated potato article comprises blowing air on the fried, batter-coated potato article for a time of about 2-3 seconds at ambient temperature.

In an embodiment of the present disclosure, the process optionally comprises a freezing step 228. For example, the fried, batter-coated food article such as the fried, batter-coated potato article is optionally chilled and then subsequently frozen under conditions to obtain a frozen, fried, batter-coated food article such as a frozen, fried, batter-coated potato article. Such conditions are known in the art and the selection of suitable conditions to obtain the frozen, fried, batter-coated food article such as the frozen, fried, batter-coated potato article can be made by a person skilled in the art. In an embodiment, the frozen, fried, batter-coated food article such as the frozen, fried, batter-coated potato article has a temperature of a maximum of about −8° C. It will be appreciated that the frozen, fried, batter-coated food article such as the frozen, fried, batter-coated potato article can be packaged using techniques that are well known to a person skilled in the art.

In an embodiment, the processes of the present disclosure optionally comprise a reconstitution step. Methods for reconstituting a frozen, fried, batter-coated food article such as a frozen, fried, batter-coated potato article are known in the art and include, for example, reconstitution frying, reconstitution oven baking, reconstitution microwaving and reconstitution using a combination oven.

In an embodiment, the processes of the present disclosure optionally comprise a reconstitution frying step. For example, the frozen, fried, batter-coated food article such as the frozen, fried, batter-coated potato article is fried under conditions to obtain a finish-fried, batter-coated food article such as a finish-fried, batter-coated potato article, for example a finish-fried, batter-coated French fry. Such conditions may vary, for example based on the size and/or the shape of the food article such as the potato article. The selection of suitable conditions to obtain the finish-fried, batter-coated food article such as the finish-fried, batter-coated potato article can be made by a person skilled in the art. In an embodiment, the finish-fried, batter-coated food article is a finish-fried, batter-coated ⅜ cut French fry and the conditions to obtain the finished-fried, batter-coated French fry comprises frying in a suitable oil for a time of about 3 minutes at a temperature of about 175° C. In another embodiment, the finish-fried, batter-coated food article is a finish-fried, batter-coated 19/64 cut French fry and the conditions to obtain the finished-fried, batter-coated French fry comprises frying in a suitable oil for a time of about 2 minutes at a temperature of about 180° C. In a further embodiment, the finish-fried, batter-coated food article is a finish-fried, batter-coated 9116 cut French fry and the conditions to obtain the finished-fried, batter-coated French fry comprises frying in a suitable oil for a time of about 3 minutes and 45 seconds at a temperature of about 180° C.

In another embodiment, the processes of the present disclosure optionally comprise a reconstitution oven baking step. For example the frozen, fried, batter-coated food article such as the frozen, fried, batter-coated potato article is oven baked under conditions to obtain an oven baked, batter-coated food article such as an oven baked, batter-coated potato article, for example an oven baked, batter-coated French fry. Such conditions may vary, for example based on the size and/or the shape of the food article such as the potato article. The selection of suitable conditions to obtain the oven baked, batter-coated food article such as the oven baked, batter-coated potato article can be made by a person skilled in the art. In an embodiment, the oven baked, batter-coated food article is an oven baked, batter-coated ⅜ cut French fry and the conditions to obtain the oven baked, batter-coated French fry comprises reconstituting in a fan oven for a time of about 19 minutes at a temperature of about 215° C. In another embodiment, the oven baked, batter-coated food article is an oven baked, batter-coated 19/64 cut French fry and the conditions to obtain the oven baked, batter-coated French fry comprises reconstituting in a fan oven for a time of about 16 minutes at a temperature of about 210° C. In a further embodiment, the oven baked, batter-coated food article is an oven baked, batter-coated 9/16 cut French fry and the conditions to obtain the oven baked, batter-coated French fry comprises reconstituting in a fan oven for a time of about 18 minutes at a temperature of about 180° C.

In a further embodiment, the processes of the present disclosure optionally comprise a reconstitution microwaving step. For example, the frozen, fried, batter-coated food article such as the frozen, fried, batter-coated potato article is microwaved under conditions to obtain a microwaved, batter-coated food article such as a microwaved, batter-coated potato article, for example a microwaved, batter-coated French fry. Such conditions may vary, for example based on the size and/or the shape of the food article such as the potato article. The selection of suitable conditions to obtain the microwaved, batter-coated food article such as the microwaved, batter-coated potato article can be made by a person skilled in the art. In an embodiment, the microwaved, batter-coated food article is a microwaved, batter-coated ⅜ cut French fry and the conditions to obtain the microwaved, batter-coated French fry comprises reconstituting in a microwave for a time of about 3 minutes at a power of about 650 W.

### III. Steam Treatment Apparatus

Wet saturated steam can transfer a large amount of latent heat energy very quickly, together with the moisture useful for the processes of the present disclosure as the steam condenses. In contrast, superheated steam is essentially a dry gas. Although it has a very high overall heat content, superheated steam has a tendency to remove moisture which is not useful for the processes of the present disclosure, whereas wet saturated steam has a tendency to condense and deliver water to the environment, which is useful for the processes of the present disclosure. Generating saturated steam can be done, for example by boiling water pans or by de-superheating direct injected steam so that it is in a saturated condition able to release its heat content. Control so as not to overcool is useful in such a method of generation.

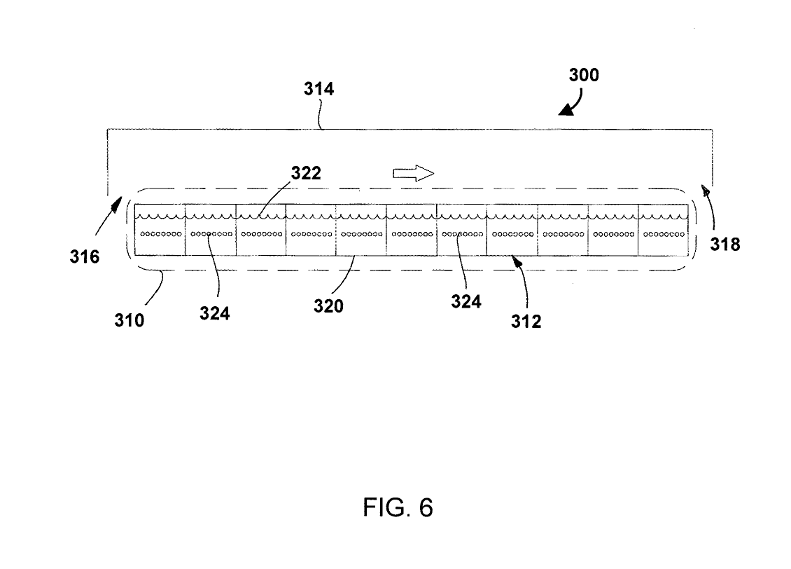

Referring now to FIG. 6, there is shown a steam treatment apparatus generally designated 300. The apparatus 300 includes a conveyor 310, a steam generating arrangement 312 and a hood 314. The conveyor 310 extends around the steam generating arrangement 312. The hood 314 is spaced from the conveyor 310 such that apertures 316, 318 are provided to allow product to be placed onto and removed from the conveyor 310.

The steam generating arrangement 312 optionally includes a reservoir 320 for a volume of water, the free surface of which is indicated by line 322. The steam generating arrangement 312 is further provided with a piping network 324 through which steam is passed, in use. The piping network 324 is provided below the water free surface 322. The piping network 324 is connected to a steam source and a condensate collection and removal arrangement. It will further be noted that the reservoir 320 is divided into a plurality of compartments. In an alternative embodiment the reservoir 320 may comprise a single compartment (not shown).

In use, steam at a pressure of between 4 to 20 bar gauge from the steam source is passed through the piping network 324. The continued passage of steam through the piping network 324 causes the water present in the reservoir to enter a boil condition, typically a rolling boil condition. This results in the generation of saturated steam at a temperature of from 95° C. to 120° C. at a pressure which is at or only slightly above the ambient atmospheric pressure. Air curtains to limit the escape of steam are optionally provided at the apertures 316,318. A level sensor (not shown) optionally monitors the height of the water free surface 322 and causes additional water to be added to the reservoir 320 if the water level drops below a predetermined minimum height. The product supporting surface of the conveyor 310 may be provided, for example, at a position that is between 200 mm and 1000 mm above the free surface 322 of the water in the reservoir 320.

In use, the conveyor 310 is operated to conduct food articles into, through and out of the saturated steam. The food articles are thus exposed to the saturated steam which causes gelatinisation of starch present upon the surface of the food article or present in a batter coating covering the food article. For food articles having a coating, the apparatus 300 may be provided, for example between a coating station and an oil fryer. For example, for food articles having a coating, the apparatus 300 may be provided, for example between a set/drip belt (which is after a coating station) and an oil fryer. For food articles comprising portions of starchy vegetables without batter, the apparatus 300 may be provided between a dryer and an oil fryer.

In use, the body of water may be heated to provide saturated steam at a temperature of from 95° C. to 120° C., for example about 100° C. The speed of the conveyor 310 is such that the transit time for a food article through the steam vessel is at least 10 seconds. Typically, the transit time is from 10 to 40 seconds, for example about 18 seconds.

In the embodiment described above, the water present in the reservoir 320 is heated and caused to boil by the provision of the submerged piping network 324 through which steam is circulated. It will be appreciated by a person skilled in the art that other means may be provided to heat the water and to cause it to boil. For example, there may be provided one or more submerged electric heating elements. Alternatively, one or more burners may be provided which are arranged to heat a surface, for example the base, of the reservoir 320 and hence cause the water to boil.

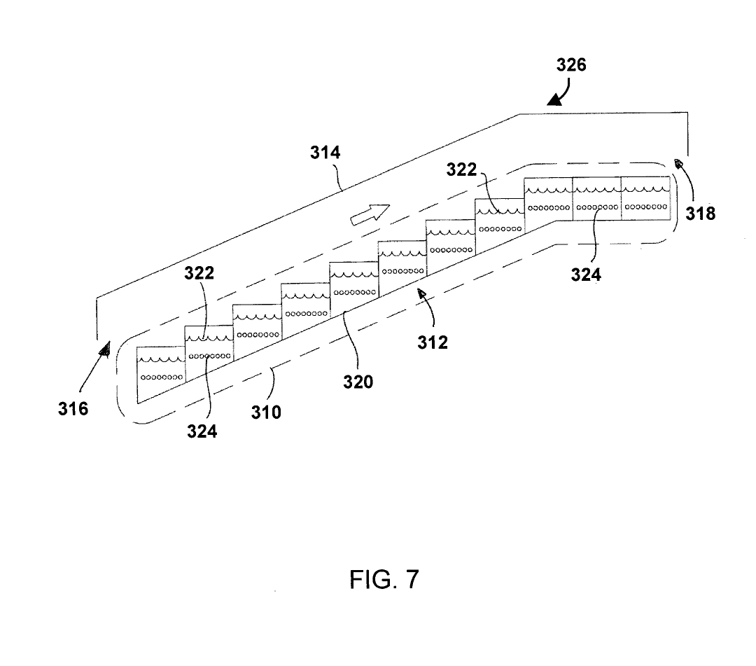

FIG. 7 shows an alternative embodiment of a steam treatment apparatus generally designated 326. Features common to the embodiment described with reference to FIG. 6 are identified with like reference numerals. The apparatus 326 differs in that the conveyor 310 is inclined.

According to another aspect of the present disclosure there is provided a steam treatment apparatus for exposing a food product that is at least partially formed from a vegetable and coated in a batter coating containing starch, or a food product that is a portion of a starchy vegetable to steam, the apparatus comprising a steam generating arrangement, a conveyor and a hood surmounting the conveyor, wherein the steam generating arrangement contains a reservoir containing a body of water and a heating arrangement operable to heat the body of water and to cause it to boil.

The present disclosure provides an apparatus which is capable of generating a saturated steam environment within the steam vessel and through which food product may be conveyed by the conveyor.

The heating arrangement may comprise a submerged piping network through which steam can be circulated.

The heating arrangement may optionally heat the body of water to generate saturated steam at a temperature of between 95° C. and 120° C., for example about 100° C. The speed of the conveyor may be such that the transit time for a food product through the steam vessel is at least 10 seconds. Optionally the transit time is between 10 and 40 seconds, for example about 18 seconds.

The present disclosure also includes a steam treatment apparatus for exposing a food article, for example a food product that is at least partially formed from a vegetable and coated in a batter coating containing starch, or a food product that is a portion of a starchy vegetable to steam, the apparatus comprising a steam generating arrangement, a conveyor and a hood surmounting the conveyor, the conveyor passing through the hood.

For example, the steam generating arrangement can comprise a reservoir containing a body of water to form saturated steam, the reservoir in fluid communication with the hood to convey the saturated steam to the hood and create a saturated steam environment therein.

In an embodiment, the steam delivery to the food article from the steam generating arrangement is from the top (hood), bottom or both.

Optionally, the steam generating arrangement comprises a unit which mixes steam and water to generate saturated steam, for example at a temperature of about 95° C. to about 120° C., for example about 100° C.

Optionally, the steam generating arrangement comprises a water trap arrangement of cooled water to deliver saturated steam, for example at a temperature of about 95° C. to about 120° C., for example about 100° C., for example as a regulated volume.

Optionally, the steam generating arrangement comprises a vessel, and superheated and saturated steam is passed through the bottom and/or top of the vessel into condensing steam/water so that the steam that reaches the conveyor is fully saturated and has, for example a temperature of from about 95° C. to about 120° C., for example about 100° C.

### IV. Fried Food Articles

In the present disclosure, processes for preparing fried, batter-coated food articles such as fried, batter-coated potato articles, for example fried, batter-coated French fries have been developed. Fried, batter-coated food articles such as fried, batter-coated potato articles, for example fried, batter-coated French fries have been prepared using such processes.

Accordingly, the present disclosure also includes a fried, batter-coated food article prepared according to a process for producing a fried, batter-coated food article of the present disclosure.

In an embodiment of the present disclosure, the fried, batter-coated food article is a fried, batter-coated vegetable article. In another embodiment, the fried, batter-coated vegetable article is a fried, batter-coated onion article such as a fried, batter-coated onion ring. In a further embodiment, the vegetable article optionally further comprises additional food components such as non-vegetable components. In another embodiment, the fried, batter-coated food article is a fried, batter-coated root vegetable article. In a further embodiment, the fried, batter-coated food article is a fried, batter-coated tuberous root vegetable article. It is an embodiment that the fried, batter-coated food article is a fried, batter-coated potato article. In an embodiment, the fried, batter-coated potato article is prepared from a potato article comprising at least a portion of any processing variety of potato or any processing variety of sweet potato. In another embodiment, the potato article is selected from a whole potato, a potato half, a potato quarter, a potato wedge, a potato strip or stick, a potato cube, a potato slice and a novelty cut of potato such as but not limited to a spiral shape. In another embodiment, the potato article is selected from a potato wedge and a potato strip or stick. In a further embodiment, the potato article is a potato strip or stick. In an embodiment, the potato article is a 9/32 to 19/64 inch cut for shoestring cut French fries or a 3/16 inch to 1.5 inch cut for square cut French fries. Optionally, the potato articles are sliced for 9/16 or 19/64 inch cut French fries. It is an embodiment that the fried, batter-coated food article is a fried, batter-coated French fry or a fried, batter-coated sweet potato fry. In another embodiment, the fried, batter-coated food article is a fried, batter-coated French fry. In an embodiment, the fried, batter-coated food article is a fried, batter-coated sweet potato fry. The selection of a suitable cut, for example for a fried, batter-coated French fry or a fried, batter-coated sweet potato fry can be made by a person skilled in the art.

It will be appreciated by a person skilled in the art that further embodiments of the fried, batter-coated food article prepared according to a process of the present disclosure can be varied as discussed herein in relation to corresponding embodiments of the processes of the present disclosure.

### EXAMPLES

### Example 1

### I. Materials and Methods

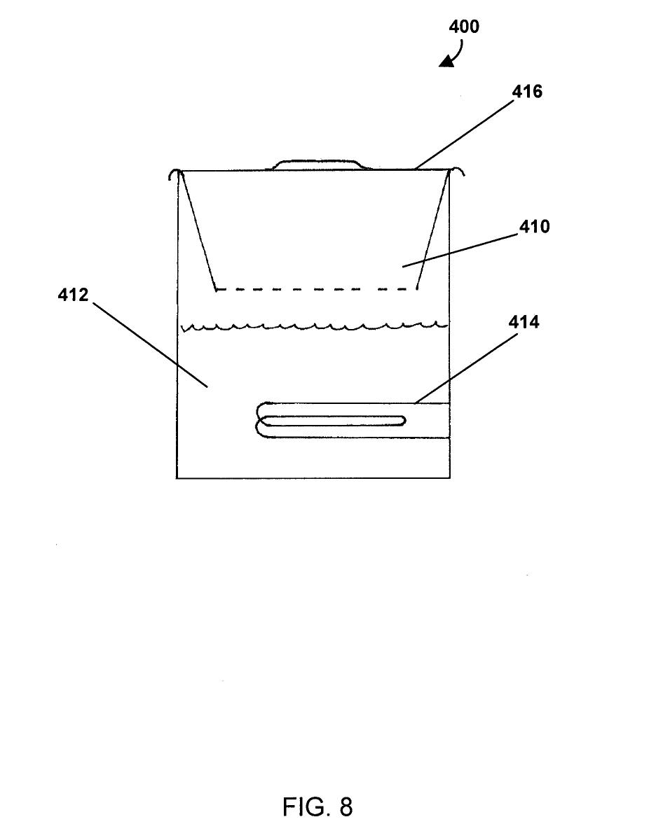

FIG. 8 shows a schematic of a modified Burco boiler 400 that was used as a source of steam for the initial trials. Referring to FIG. 8, batter-coated potato articles (not shown) are placed in a wire mesh basket 410 that is positioned above the level of the water 412. A heating element 414 heats the water 412 to boil the water, to obtain the steam (not shown). A lid 416 keeps the steam surrounding the batter-coated potato articles.

Batter compositions tested in the initial trials are listed in Table 2. The corresponding steam temperatures and exposure times that were used for each of these batters are listed in Table 3. Further product and processing details for various cuts of potato articles are provided in Table 4. Steam times tested were from 11 seconds to 40 seconds and frying times tested were from 40 seconds to 80 seconds at 185° C.

### II. Results and Discussion

All of the tested batters gelatinized and therefore exhibit reduced shedding of batter from the potato article when it is placed in an oil fryer. This reduces batter crumb contamination of the frying oil. The gelatinized batter prevents moisture migrating into the batter from the blanched potato article during frying. All are capable of cooking in a single fry step.

Fried, batter-coated French fries produced by a process having a step of contacting potato strips coated with batter 5 of Table 2 with steam for a time of 18 seconds at a temperature of 100° C., were observed to have a 50% reduction in fryer crumb and a 16% reduction in oil use in comparison to fried, batter-coated French fries prepared by a standard (non-oil) process.

### Example 2

### I. Materials and Methods

The batter compositions tested in these trials are listed in Table 2. The potato articles tested were 9/16 cut French fries. The French fries were processed to the end of the drying step in the standard way using the parameters set out in Table 4 for 9/16 cut French fries. The steam time was 18 seconds at a temperature of 100° C. The steaming apparatus used in these trials is represented schematically in FIG. 7.

Batter was removed from the spillage points on the line and a solids measurement was taken using a Sartorius Moisture Analyzer. A mass balance was done to establish where batter solids had been wasted. The oil content was tested using acid hydrolysis followed by petroleum spirit extraction.

### II. Results and Discussion

A five second intermediary set/drip belt was installed and was observed to deliver sufficient reduction in batter carry-over onto the belt that made the system able to run for an extended period (about 24 hours). The intermediary set/drip belt is a useful embodiment because it reduces likelihood of gelatinised batter forming that could potentially exceed belt-wash capacity and compromise water baths.

These trials were validated by both microscopy and sensory analysis of products made under the two processes.

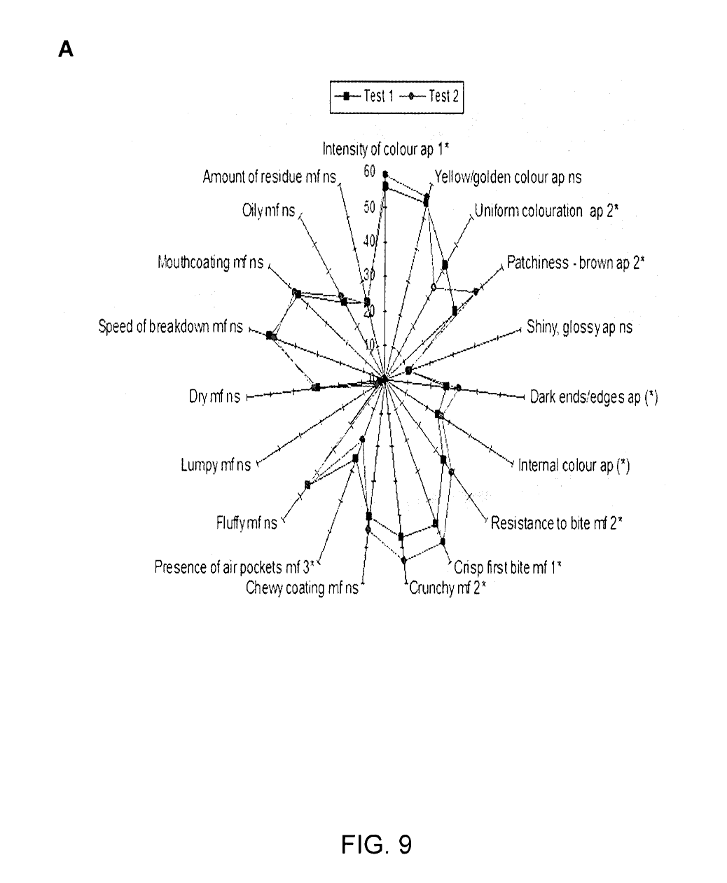

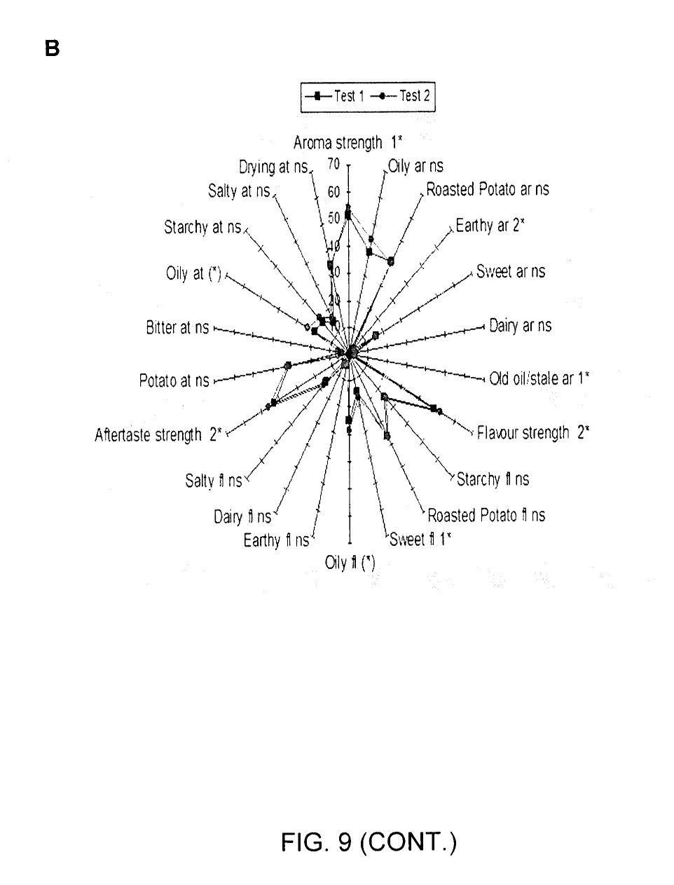

FIG. 9 shows data from sensory testing of fried, batter-coated French fries produced according to a standard procedure (Test 1) in comparison to fried, batter-coated French fries produced by a process which used a steaming step (Test 2). Even though the fried, batter-coated French fries produced using the process having a steaming step had 15% less batter and oil than the fried, batter-coated French fries produced by a standard (non-steam) process, the sensory results were similar.

Results from these trials showed that 3.6 wt % batter on French fries and a corresponding amount of oil prepared using the process comprising the steaming step performs as well for crispness as 4.25 wt % batter on French fries and a corresponding amount of oil prepared using a standard (non-steam) process. Crumb generation in the fryer was observed to be reduced from 4.86 kg/tonne produced using a standard process to 0.78 kg/tonne produced using the process comprising a steaming step. Waste from the steaming step was observed to be 11.78 kg/tonne.

### III. Summary

The quality of fried, batter-coated French fries produced by the process having a steaming step were a very good match to products produced by a standard (non-steam) process. The flavour in the fried, batter-coated French fries produced by the process having a steaming step was not affected by the reduction in batter solids and oil in comparison those produced by the standard (non-steam) process.

The machine ran continuously without the belt blinding when it comprised an increased belt washing system and an intermediate belt between the enrober and the steamer unit giving approximately 5 seconds of drip time. This equates to a reduction of batter drip off into the steamer unit of about 1000 L/hr. Although this allowed the steamer unit to operate, the amount of batter used meant that it generated waste.

### Example 3

### Further Trials Using a Set/Drip Belt

Previous testing of the present disclosure showed that using a process having a steaming step to produce fried, batter-coated French fries results in a more efficient use of the available starches, and therefore reduction in the amounts of batter needed to maintain the same texture in comparison to similar fried, batter-coated French fries produced by a standard (non-steam) process. Further testing using a set/drip belt was carried out.

### II. Materials and Methods

For product other than that which is going for sensory evaluation a system needs only to be run on potato articles that have the correct surface conditions, for example a short blanch and dry are acceptable to get the batter to adhere correctly to the potato article. Accordingly, only potato articles used for fried, batter-coated French fries to be used for sensory analysis from both the steam and non-steam processes were blanched and dried to give the correct internal texture. The other potato articles were only blanched and dried to give the correct surface texture to allow the batter to stick correctly and give the correct pick-ups to reduce processing time and allow a higher line rate.

All tests were duplicated for both 9/16 cut French fries and for 19/64 cut French fries to study differences that may be seen through cut size. The steam time was 18 seconds at a temperature of 100° C. The steaming apparatus used in these trials delivered steam from a unit which mixes steam and water to generate saturated steam. The potato articles were fed into the process comprising a steaming step at a line rate of up to 225 kg/hour.

### French Fry Enrobing

9/16 cut French fries were coated in batter 5 of Table 2. For the standard (non-steam) process, solids in the batter were from 38-40 wt % (3.9-4.8 wt % batter on fries), pick-up was targeted at 11% (10-12%) and viscosity using a B6 flow cup was 11 seconds. For the process comprising a steaming step, solids in the batter were from 36-38% (3.24-4.18% batter on fries), pick-up was targeted at 10% (9-11%) and viscosity using a B6 flow cup was 10 seconds.

19/64 cut French fries were coated in a batter that was similar to batter 5 of Table 2 except that salt was reduced by about 50% and the difference in weight was spread between the other ingredients. For the standard (non-steam) process, solids in the batter were from 37-40% (6.66-8% batter on fries) and pick-up was targeted at 19% (18-20%). For the process comprising a steaming step, solids in the batter were from 36-38% (5.94-7.03% batter on fries) and pick-up was targeted at 17.5% (16.5-18.5%). For both processes, viscosity using a B6 flowcup was 11 seconds.

### II. Results and Discussion

As the steaming step increased the performance of the starches in the batters, less batter was needed in the process comprising a steaming step to create a product similar to that produced by a standard process.

### Batter and Oil

Extended runs of both steam and non-steam processes were conducted and the products produced from the two processes compared to each other. Blanched and dried French fries were taken from an existing process line to give a large amount of consistent material.

To establish the batter losses in the system under both processes the batter powder was weighed before it was mixed and summed at the end of the trial. All batter not applied to the French fries at the end of the process was tracked by collecting the batter as it dripped from the French fries, collecting the batter from the machines after processing and using a microwave method to establish the solid level of the batter. In this method, about 10 grams of batter is heated in a microwave to remove moisture. The weight of the batter after microwaving subtracted from the weight of the batter before microwaving determines the water content of the batter.

After the trial, the oil from the fryer was drained with the crumb collected in the filter of the catch box as well as all debris from the bottom of the fryer. The crumb collected was assumed to be 50% oil and 50% batter solids. By doing this all batter should have been accounted for and an accurate number for the amount of batter on the fries established.

Oil pickup and finished solid levels were measured using acid hydrolysis followed by petroleum extraction and batter usage was measured by measuring how much batter is put into the system throughout the run less the amount remaining at the end. All batter remaining in the system was assumed to be homogenous and of the same solids content as a single test on it.

Five samples were enough samples to find a statistically significant difference in the present studies.

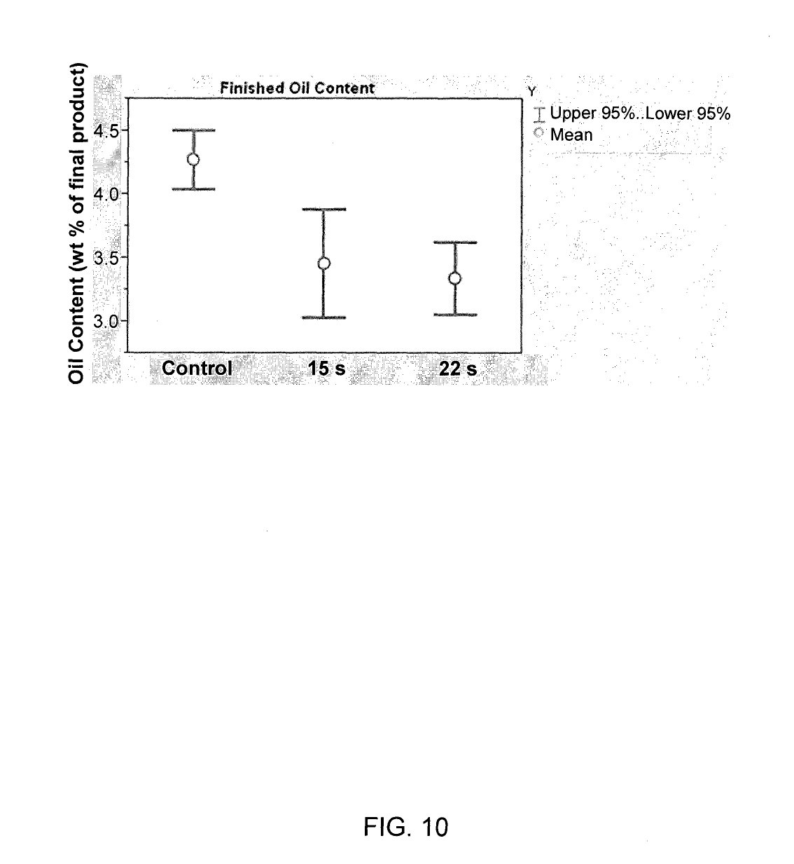

FIG. 10 shows the reduction in oil that was observed with the present process as a function of the set/drip belt time.

Savings of 0.52 wt % of finished product in batter usage and 0.52 wt % savings in oil have been observed. This is a reduction of 12.5% on the current levels as taken from validated commercial trials.

The reduction in oil and batter usage has been shown in the present trials to be similar for both 9/16 and 19/64 cut French fries, showing that the process is useful across a range of cut sizes without affecting the savings. The savings observed for the present setup may be higher in a process that includes components for optimization such as but not limited to air knives and/or viscosity controlled batter enrobing.

### Moisture Content

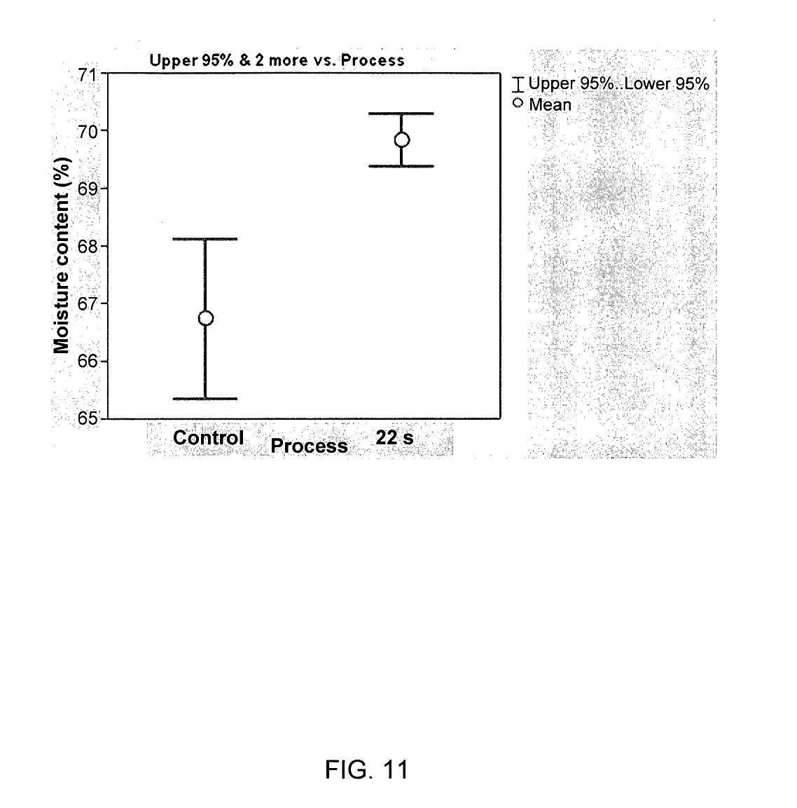

FIG. 11 shows how the difference in fry loss leads to a statistically significant change in the amount of moisture in the final product. The product produced by a standard (non-steam) process (control) resulted in a lower moisture content than the product produced by the process comprising a steaming step and a 22 second set/drip belt (22 s).

### Assessment of Losses

The trials of Example 2 generated the predicted savings from batter required on product to gain the required/comparable texture. Waste came from batter losses in the system. The following exercises were undertaken to assess, and reduce loss: The dwell time on the drip belt before the steamer unit was increased to a value of 5 seconds and run for 4 hours (about 300 kg total) with the steamer unit operating. This should increase the carry-over into the steamer unit like the trials of Example 2. After the run, all the batter in the steamer unit was cleaned out and weighed to provide a weight of batter solids that were in the steamer unit, including all cleaning water. The fryer was drained to weigh the crumb created during the trials.

Waste crumb generated under a standard system has been observed to be 4.86 kg per tonne product produced ( 9/16 cut French fries). This contains 50 wt % batter solids and 50 wt % oil. As no steaming step is used in the standard process, waste from a steaming step is equal to 0%.

Waste crumb generated using a 5 second set/drip belt arrangement of a process comprising a steaming step in the present trials has been observed for 9/16 cut French fries to be 1.29 kg of batter/tonne product produced. Waste from the steaming step was observed to be 18.16 kg/tonne.

Waste crumb generated using a 22 second set/drip belt arrangement of a process comprising a steaming step in the present trials has been observed for 9/16 cut French fries to be 1.1 kg of batter/tonne product produced. Waste from the steaming step was observed to be 5.39 kg/tonne.

### Set/Drip Time

Measuring drip time in the studies of the present disclosure showed that drip off reduces over time following an exponential decay curve. Measurements in the present studies showed that batter waste reduced from 28% at 5 seconds, to 15% at 15 seconds to 12% at 22 seconds and that there was no significant impact delivered on batter on fries after the fryer.

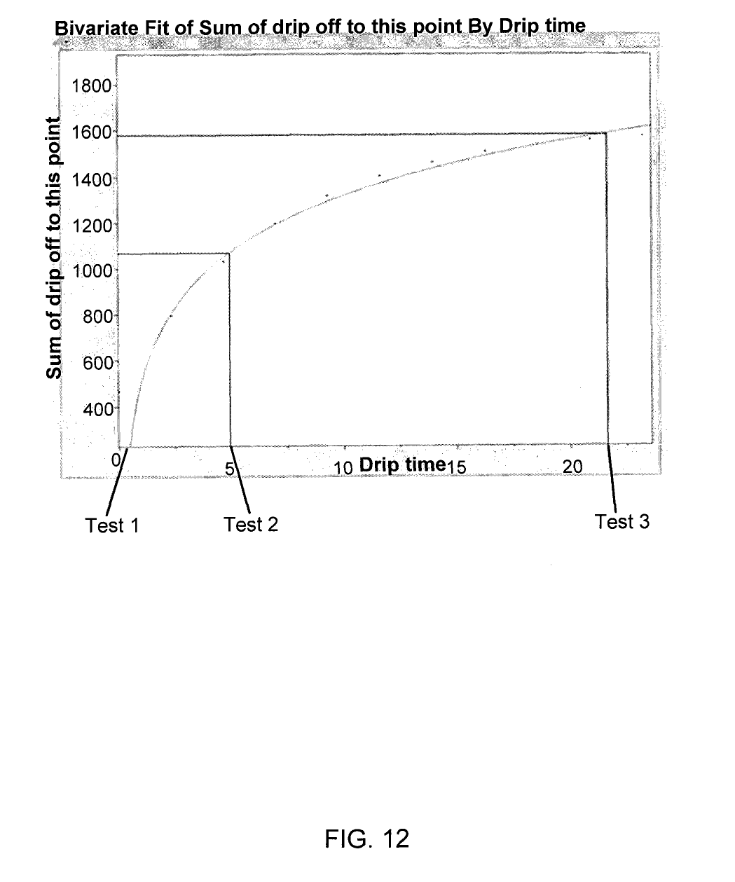

FIG. 12 is derived from data collected from a line running 9/16 cut French fries and shows the amount of batter that has dripped from the product per hour at different times on the set/drip belt. Any remaining batter that has not dripped from the product is free to drip off later in the process. In FIG. 12, Test 1: Batter drip off into the steam unit of about 1600 L/hr. Test 2: Batter drip off into the steam unit of about 600 L/hr. Test 3: Batter drip off into the steam unit of about 100 L/hr provided better results.

### Welding of French Fries

During the steaming process, French fries that are stuck together will inhibit steam from penetrating the join, meaning that the batter does not set. The wet batter means the French fries may then fall apart before the fryer. Two French fries that have set in the steamer will not weld and so there is a large reduction in overall welding. This was seen to be happening during the present trials where the control test produced a significantly higher number of welds than the steam process.

### Sensory Testing

Samples were sent for sensory testing to test whether it had the same quality as that produced by a standard process.

Sensory testing showed that the product made in the present trials is a match for the standard process which had a higher Batter on Fries (BOF). BOF is the percentage by weight of batter solids that are applied to a product and is calculated by BOF=(batter solids %×pick-up %)/100.

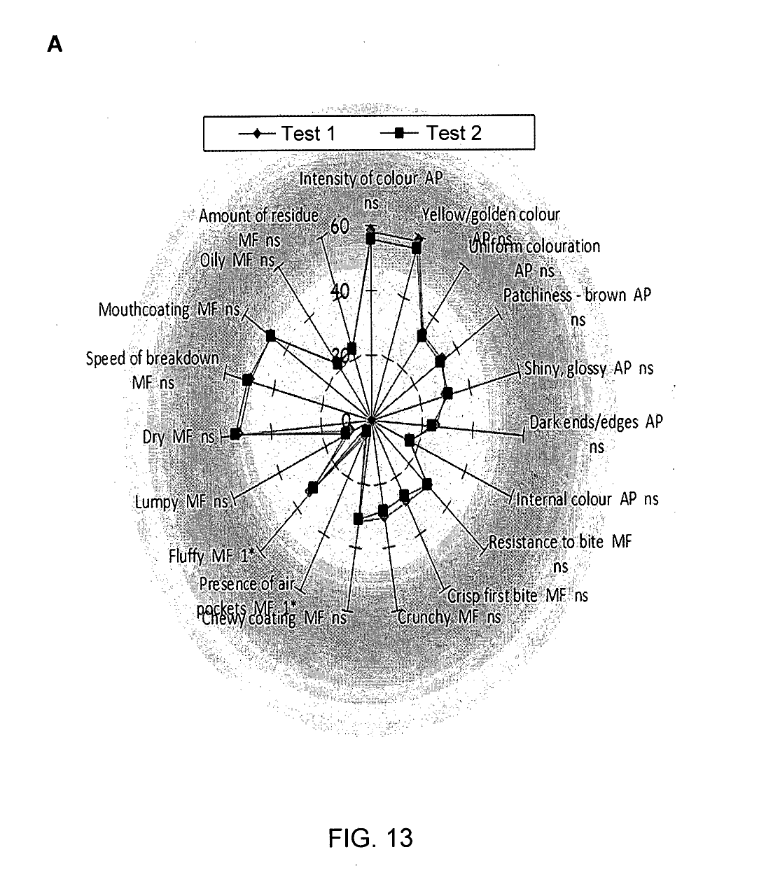

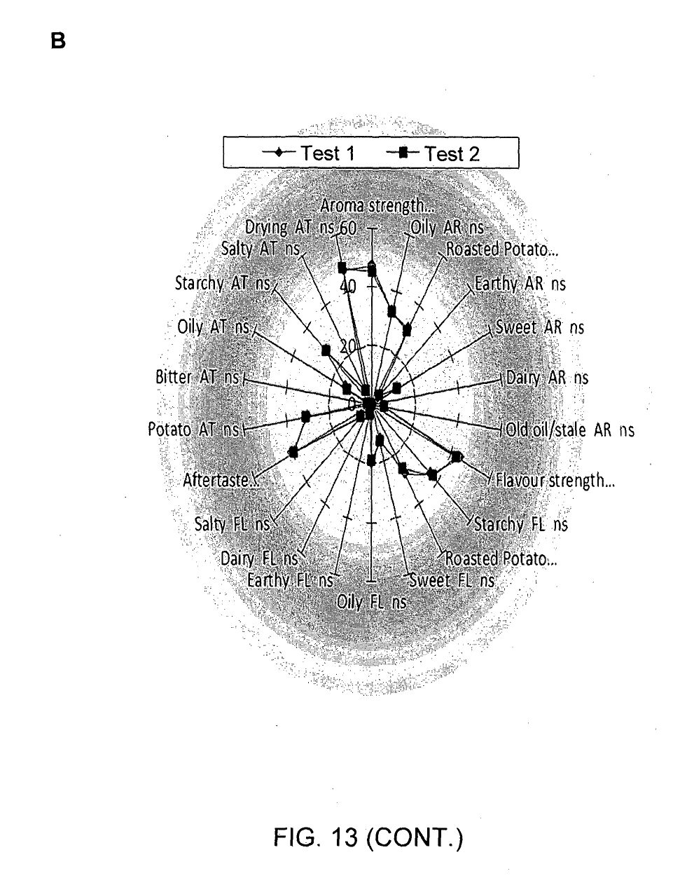

The sensory charts shown in FIG. 13 show that both the control and the product produced by the present trials had the same sensory performance despite the fact that the product produced by the present trials contained more water (1 wt %), less oil (greater than a 20 wt % reduction), and less batter (greater than a 20 wt % reduction). Useful financial savings may be obtained in a production line using such a process.

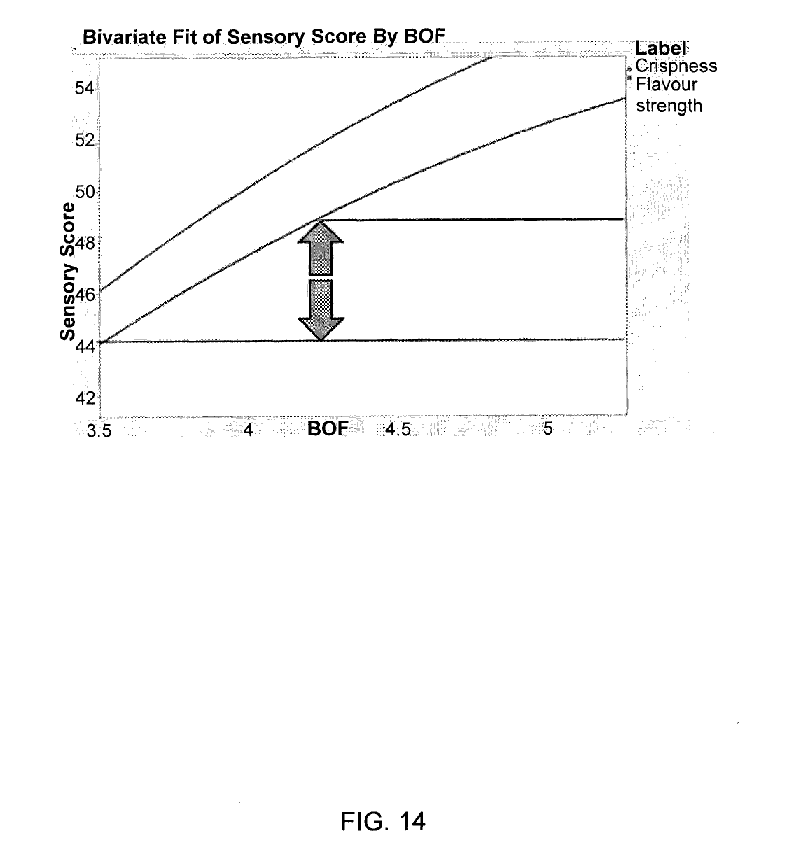

As shown in FIG. 14, studies have demonstrated that there is a fairly linear relationship between the amount of batter/oil in the product and sensory performance. The same performance cannot normally be achieved through a reduction in batter and oil on their own. The arrow in FIG. 14 indicates the degree to which the process comprising a steaming step has improved batter efficiency over a standard (non-steam) process.

The process comprising a steam-treatment step has generated a minimum of about 15% and up to about 25% increase in performance of the batter within the product produced in comparison to a product produced by a standard process. Surprisingly, the present studies showed that the flavour was not affected by the reduction in batter solids and oil.

### III. Comments on Excess Batter

Excess batter is batter that is not held in place by viscosity alone. If the external forces on the batter exceed the viscosity then the batter will drip off and will do so regardless of whether it is passed through air, steam, or oil. The present studies shows there is a choice to determine where it drips off, and therefore whether it is reclaimed for re-use (set/drip belt), is lost in the process (in the steamer) or whether it is lost as batter crumb (in which case it takes an equivalent mass of oil with it).

It has been demonstrated through repeat tests in multiple facilities, that set/drip time is useful for minimizing the amount of crumb (waste) generated in a fryer. Extending drip/set time to about 20 seconds causes a significant reduction in crumb, but a negligible effect on finished solids on French fries. While not wishing to be limited by theory, it is believed that “loose” batter i.e. batter which is not held on the product by viscosity alone, “blows off” in the fryer as there is no substrate interaction to keep it in place. In the process of the present studies, increasing set/drip time from about 5 to about 20 seconds delivered an about 65% or greater reduction in crumb.

While the present application has been described with reference to what are presently considered to be the preferred examples, it is to be understood that the application is not limited to the disclosed examples. To the contrary, the application is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

TABLE 1

| Batter/Coating No. | Composition |
|---|---|
| 1 | Water (30-80%), Wheat Flour (35-65%), |
| | Rice Flour (10-20%), Potato Dextrin (5-20%), |
| | Modified Starch (2-10%); e.g. |
| | Water 30-80%, Flour (Wheat and Rice) |
| | 40-85%, Dextrin 5-30%, Salt 0-10%, |
| | Modified Starch 0-10%, Colour (Turmeric |
| | Extract, Paprika Extract) 0-10%, Vegetable |
| | Oil 0-10%. |
| 2 | Water (30-80%), Modified Starch (30-50%), |
| | Rice Flour (5-20%), Wheat Starch |
| | (5-20%), Potato Dextrin (5-20%); e.g. |
| | Water 30-80%, Modified Starch 30-70%, |
| | Rice Flour 5-30%, Starch 5-30%, Dextrin |
| | 5-30%, Salt 0-10%, Raising Agents (E450, |
| | E500) 0-10%, Stabiliser (Xanthan Gum) |
| | 0-10%. |
| 3 | Water (30-80%), Wheat Flour (40-65%), |
| | Wheat Starch (10-30%), Seasoning (5-30%); |
| | e.g. |
| | Water 30-80%, Wheat Flour 30-85%, |
| | Wheat Starch 5-30%, Seasoning 5-30%, |
| | Salt 0-10%, Colour (Paprika Extract) 0-10%, |
| | Vegetable Oil 0-10%. |
| 4 | Water (30-80%), Wheat Flour (40-65%), |
| | Wheat Starch (5-30%), Seasoning (1-15%), |
| | Salt (1-15%); e.g. |
| | Water 30-80%, Wheat Flour 30-65%, |
| | Wheat Starch 5-30%, Salt 1-15%, |
| | Seasoning 1-15%, Colour (Paprika |
| | Extract) 0-10%, Vegetable Oil 0-10%. |
| 5 | Water (30-80%), Wheat Flour (35-65%), |
| | Rice Flour (10-20%), Modified Starch (2-10%), |
| | Salt (0-10%), Maize Starch (0-10%); |
| | e.g. Water 35-80%, Flour (Wheat and |
| | Rice), 35-80%, Modified Starch 10-45%, |
| | Salt 0-10%, Starch 0-10%, Colour |
| | (Turmeric Extract, Paprika Extract) 0-10%, |
| | Vegetable Oil 0-10%. |
| 6 | Water (30-80%), Modified Starch (50-70%), |
| | Rice Flour (5-20%), Salt (0-10%); |
| | e.g. Water 35-80%, Modified Starch 50-90%, |
| | Rice Flour 0-30%, Salt 0-10%, |
| | Stabiliser (Xanthan Gum) 0-10%. |

TABLE 2

| | Batter 1 (wt %) | Batter 2 (wt %) | Batter 3 (wt %) | Batter 4 (wt %) | Batter 5 (wt %) | Batter 6 (wt %) |
|---|---|---|---|---|---|---|
| Water | 40.00 | 40.00 | 36.00 | 36.00 | 38.00 | 38.00 |
| Wheat Flour | 30.00 | — | 31.40 | 35.00 | 30.69 | — |
| Rice Flour | 15.00 | 9.00 | — | — | 6.95 | 4.00 |
| Potato Dextrin | 8.00 | 6.00 | — | — | — | — |
| Salt | 2.90 | 2.95 | 1.00 | 1.40 | 3.91 | 2.95 |
| Wheat Starch | — | — | 19.59 | 19.59 | — | — |
| Maize Starch | — | 8.00 | — | — | 6.94 | — |
| Modified Starch | 4.00⁵ | 33.40⁵ | — | — | 13.50⁶ | 55.00⁷ |
| Color Extracts¹ | 0.05 | — | 0.05 | 0.05 | 0.05 | — |
| Vegetable Oil | 0.05 | — | 0.05 | 0.05 | 0.05 | — |
| Raising Agents² | — | 0.60 | — | — | — | — |
| Stabiliser³ | | 0.05 | — | — | — | 0.05 |
| Seasoning⁴ | — | — | 12.00 | 8.00 | — | — |
| Total | 100.00 | 100.00 | 100.00 | 100.00 | 100.00 | 100.00 |

¹Paprika and turmeric.
²E450, E500.
³Xanthan gum.
⁴Blend including garlic, onion, herbs and spices and chili.
⁵Modified potato starch.
⁶Blend of modified maize starch and tapioca dextrin.
⁷Blend of modified tapioca starch and modified high amylose maize starch.

TABLE 3

| | Batter 1 | Batter 2 | Batter 3 | Batter 4 | Batter 5 | Batter 6 |
|---|---|---|---|---|---|---|
| Steam | 100 | 100 | 100 | 100 | 100 | 100 |
| temperature | | | | | | |
| (° C.) | | | | | | |
| Exposure time | 18 | 20 | 15 | 15 | 15 | 20 |
| (seconds) | | | | | | |

TABLE 4

| | Cut size | | | |
|---|---|---|---|---|
| | 3/8 | 9/16 | 19/64 | 8 cut wedge |
| Blanch | 5 minutes at 85° C. | 10 minutes at 85° C. | 7 minutes at 85° C. | 12 minutes at 85° C. |
| Dip | 1 minute at 65° C. | 1 minute at 65° C. | 1 minute at 65° C. | 1 minute at 65° C. |
| Dry Loss | 9% | 10% | 8% | 5.20% |
| Batter Pick-up | 13% | 14% | 17% | 17% |
| Viscosity (B6 flowcup) | 4 seconds | 10.5 seconds | 11 seconds | 12 seconds |
| Solids | 36% | 40.80% | 31% | 32% |

1. A process for producing a fried, batter-coated food article, the process comprising:
coating a food article with a batter comprising starch to obtain a batter-coated food article;
contacting the batter-coated food article with saturated steam to obtain a batter-coated food article having gelatinised starch;
frying the batter-coated food article having gelatinised starch to obtain the fried, batter-coated food article; and
optionally freezing the fried, batter-coated food article.

2. The process of claim 1, wherein the food article is a vegetable article.

3. The process of claim 2, wherein the process comprises:
coating a blanched vegetable article with a batter comprising starch to obtain a batter-coated vegetable article;
contacting the batter-coated vegetable article with saturated steam to obtain a batter-coated vegetable article having gelatinised starch;
frying the batter-coated vegetable article having gelatinised starch to obtain the fried, batter-coated vegetable article; and
optionally freezing the fried, batter-coated vegetable article.

4. The process of claim 3, wherein the blanched vegetable article is prepared by steps comprising:
blanching a vegetable article under conditions to obtain a freshly blanched vegetable article;
contacting the freshly blanched vegetable article with a solution that inhibits surface discoloration of the blanched vegetable article to obtain a blanched, dipped vegetable article; and
partially drying the blanched, dipped vegetable article to obtain the blanched vegetable article.

5. The process of claim 1, further comprising setting/dripping the batter-coated food article to remove excess batter prior to contacting the batter-coated food article with saturated steam.

6. The process of claim 5, wherein the batter-coated food article is set/dripped for a time of about 20 seconds to about 25 seconds.

7. The process of claim 1, wherein the saturated steam is at a temperature of from about 95° C. to about 120° C.

8. The process of claim 1, wherein the batter-coated food article contacts the saturated steam for at least about 10 seconds.

9. The process of claim 8, wherein the batter-coated food article contacts the saturated steam for a time of about 10 seconds to about 40 seconds.

10. The process of claim 1, wherein the batter-coated food article is moved through the saturated steam on a conveyor.

11. A fried, batter-coated food article prepared according to a process of claim 1.

12. A process for producing a fried starchy vegetable food article, the process comprising the steps of:
optionally processing a vegetable portion into a desired size and shape;
blanching the vegetable portion;
contacting the vegetable portion with a solution which reduces surface discolouration
drying the vegetable portion;
contacting the vegetable portion with saturated steam to gelatinise starch present upon the surface of the vegetable portion;
frying the vegetable portion in oil; and
optionally freezing the fried vegetable portion.

13. A steam treatment apparatus for exposing a food product that is at least partially formed from a vegetable and coated in a batter coating containing starch, or a food product that is a portion of a starchy vegetable to steam, the apparatus comprising a steam generating arrangement, a conveyor and a hood surmounting the conveyor, the conveyor passing through the hood, wherein the steam generating arrangement contains a reservoir containing a body of water and a heating arrangement operable to boil the body of water to form saturated steam, the reservoir in fluid communication with the hood to convey the saturated steam to the hood and create a saturated steam environment therein.

14. A steam treatment apparatus as claimed in claim 13, wherein the heating arrangement comprises a submerged piping network through which steam can be circulated.

15. A steam treatment apparatus as claimed in claim 13, wherein the heating arrangement heats the body of water to generate saturated steam at a temperature of between 95 degrees centigrade and 120 degrees centigrade.

16. A steam treatment apparatus as claimed in claim 13, wherein the speed of the conveyor is such that the transit time for a food product through the steam vessel is at least 10 seconds.

17. A steam treatment apparatus as claimed in claim 16, wherein the transit time is between 10 and 40 seconds.

18. A steam treatment apparatus as claimed in claim 13, wherein the conveyor comprises the product supporting surface and the product supporting surface of the conveyor is positioned between 200 mm and 1000 mm above the surface of the water contained within the reservoir.

19. A steam treatment apparatus as claimed in claim 13, wherein the product supporting surface of the conveyor is horizontal.

20. A steam treatment apparatus as claimed in claim 13, wherein the product supporting surface of the conveyor is inclined.
